(19) United States
(12) Patent Application Publication
(10) Pub. No.: US 2022/0400703 A1
(43) Pub. Date: Dec. 22, 2022

(54) FORMULATIONS FOR TREATMENT OF VIBRIO INFECTIONS

(71) Applicant: ARIZONA BOARD OF REGENTS ON BEHALF OF THE UNIVERSITY OF ARIZONA, Tucson, AZ (US)

(72) Inventors: Arun DHAR, Tucson, AZ (US); Sukanniya KANESHAMOORTHY, Tucson, AZ (US); Hung MAI, Tucson, AZ (US); Sadhana RAVISHANKAR, Tucson, AZ (US)

(21) Appl. No.: 17/769,992

(22) PCT Filed: Oct. 16, 2020
(86) PCT No.: PCT/US2020/056154

§ 371 Date: Apr. 18, 2022

Related U.S. Application Data
(60) Provisional application No. 62/916,748, filed on Oct. 17, 2019.

(51) Int. Cl. A23K 10/30; A23K 20/111; A23K 50/80; A23K 20/158

(52) U.S. Cl. CPC A23K 10/30; A23K 20/111; A23K 50/80; A23K 20/158

(57) ABSTRACT

Described herein are formulations that can contain one or more plant extracts that can used to treat or prevent Vibrio spp. infection in a subject. Also described herein are methods of treating and/or preventing Vibrio spp. infection in a subject by administration of a formulation described herein. In some embodiments, the subject is a crustacean. In some embodiments, the crustacean is a shrimp.

### CROSS-REFERENCE TO RELATED APPLICATIONS

This application claims the benefit of and priority to U.S. Provisional Patent Application No. 62/916,748, filed on Oct. 17, 2019, entitled “Formulations for Treatment of Vibrio Infections,” the contents of which is incorporated by reference herein in its entirety.

### SEQUENCE LISTING

This application contains a sequence listing filed in electronic form as an ASCII.txt file entitled UAZ-0100WP_ST25.txt, created on Oct. 15, 2020 and having a size of 1,000 bytes. The content of the sequence listing is incorporated herein in its entirety.

### TECHNICAL FIELD

The subject matter disclosed herein is generally directed to treatments for Vibrio spp., particularly in crustaceans.

### BACKGROUND

Acute hepatopancreatic necrosis disease (AHPND, initially referenced to as early mortality syndrome, EMS) is a deadly shrimp disease caused by particular Vibrio spp. The disease first emerged in China in 2009 and has rapidly spread throughout Southeast Asia to Vietnam, Malaysia, Thailand and reached Mexico in Latin America. The impact of AHPND in shrimp farming at a global scale has been catastrophic with an estimated global loss of $1 billion per year. Given at least the economic impact, there exists a need for approaches to control infection by Vibrio spp.

Citation or identification of any document in this application is not an admission that such a document is available as prior art to the present invention.

### SUMMARY

Described in certain example embodiments herein are formulations comprising: an amount of each of one or more plant extracts selected from the group consisting of: cinnamon oil (CO), citral, cavacrol, oregano oil (OO), trans cinnamaldehyde (TC), and combinations thereof.

In certain example embodiments, the formulation comprises a plant extract component consisting of an amount of each of TC, OO, and cavacrol.

In certain example embodiments, the amount of CO ranges from about 10% to about 60% v/v.

In certain example embodiments, the amount of CO is about 20% v/v.

In certain example embodiments, the amount of citral ranges from about 10% to about 60% v/v.

In certain example embodiments, the amount of citral is about 20% v/v.

In certain example embodiments, the amount of cavacrol ranges from about 10% to about 60% v/v.

In certain example embodiments, the amount of cavacrol is about 20% v/v.

In certain example embodiments, the amount of OO ranges from about 10% to about 60% v/v.

In certain example embodiments, the amount of OO is about 20% v/v.

In certain example embodiments, the amount of TC ranges from about 10% to about 60% v/v.

In certain example embodiments, the amount of TC is about 20% v/v.

In certain example embodiments, the formulation comprises an amount of TC and an amount of cavacrol.

In certain example embodiments, the ratio of TC: cavacrol is 1:1.

In certain example embodiments, the formulation comprises an amount of TC and an amount of 00.

In certain example embodiments, the ratio of TC:OO is 1:1.

In certain example embodiments, the formulation comprises OO and cavacrol.

In certain example embodiments, the ratio of OO:cavacrol is 1:1.

In certain example embodiments, the formulation comprises an amount of TC, and amount of OO, and an amount of cavacrol.

In certain example embodiments, the ratio of TC:OO:cavacrol is 1:1:1.

In certain example embodiments, the formulation is effective to treat or prevent an infection caused by a Vibrio spp. organism.

In certain example embodiments, the formulation is effective to treat or prevent an infection caused by a Vibrio spp. organism in a shrimp.

In certain example embodiments, the formulation is adapted for delivery in a water source.

In certain example embodiments, the formulation is adapted for delivery via an animal feed.

Described in certain example embodiments are methods comprising: administering an amount of a formulation as in any one of paragraphs [0010]-[0033] and/or as described elsewhere herein to a subject.

In certain example embodiments, the subject is a non-human animal.

In certain example embodiments, the subject is a crustacean.

In certain example embodiments, the subject is a shrimp.

In certain example embodiments, administration is via a feed source.

In certain example embodiments, administration is via a water source.

In certain example embodiments, the subject is infected with, is suspected of being infected with an organism of a Vibrio spp., or will be exposed to an organism of a Vibrio spp.

In certain example embodiments, the subject is currently exposed to or was exposed to an organism of a Vibrio spp.

Described in certain example embodiments are methods of treating or preventing a Vibrio spp. infection in a subject comprising: administering amount of a formulation as in any one of paragraphs [0010]-[0033] and/or as described elsewhere herein to a subject.

In certain example embodiments, the subject is a non-human animal.

In certain example embodiments, the subject is a crustacean.

In certain example embodiments, the crustacean is a shrimp.

In certain example embodiments, administration is via a feed source.

In certain example embodiments, administration is via a water source.

In certain example embodiments, the subject is infected with, is suspected of being infected with an organism of a Vibrio spp., or will be exposed to an organism of a Vibrio spp.

In certain example embodiments, the subject is currently exposed to or was exposed to an organism of a Vibrio spp.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings of which:

FIG. 1 shows a schematic of virulence factor of AHPND Toxin genes (pirA & pirB) in the plasmid.

FIG. 2 shows the histopathology of HP from APHND infected P. vannamei shrimp. Adapted from Dhar et al., 2018.

FIG. 3 shows a schematic representation of disk diffusion assay (A) and Minimum Inhibitory Concentration (MIC) assay (B) to assess the efficacy of natural extracts tested in this study. SEM: Scanning Electron Microscopy, TSA+: Tryptic Soy Broth containing 2% NaCl, TCBS: Thiosulfate Citrate Bile Slat Sucrose.

FIG. 4 shows tables that can demonstrate the efficacy of plant extracts (N=23) in inhibiting Vibrio parahaemolyticus growth as measured by diameter of inhibitor zone (in mm) using a disk diffusion assay.

FIG. 5 shows images that can demonstrate results from the disc diffusion assay and show antimicrobial activity of the top 5 natural extracts on TSA+media.

FIG. 6 shows a graph that can demonstrate Antimicrobial activity of top 5 candidate natural extracts tested at different concentrations. Fish oil used as (negative, −ve) Control, and antibiotic Doxycycline hyclate (positive, +ve) Control, >7 mm considered as antimicrobial activity.

FIG. 7 shows a graph that can demonstrate V. parahaemolyticus growth (OD600) at 48 h.

FIG. 8 shows a graph that can demonstrate V. parahaemolyticus colony count at 48 h.

FIG. 9 shows a schematic diagram represents the serial dilution of natural extracts.

FIGS. 10A-10H shows images that demonstrate inhibition of Vibrio parahaemolyticus (Strain A3) growth as measured by a zone of inhibition using a paper disk diffusion assay. Natural extracts, NE01, NE02, NE03, NE04, and NE05 were tested to determine their efficacy against V. parahaemolyticus growth. A clear zone around the paper disk in each Tryptic soy agar containing 2% sodium chloride plate indicates the zone of inhibition. (+) Control=Paper disk soaked in fish oil, and a commercial antibiotic Doxycycline Hyclate at 10 μg was used as an antibiotic reference standard for the assay.

FIG. 11 shows antimicrobial activity of natural extracts, NE01, NE02, NE03, NE04 and NE05 against Vibrio parahaemolyticus (Strain A3) tested at different concentrations using a disk diffusion assay. (+) Control=V. parahaemolyticus strain A3 with fish oil, (−) Control=Paper disk soaked in Tryptic Soy Broth containing 2% Sodium Chloride, Antibiotic=Doxycycline Hyclate at 10 μg was used as an antibiotic reference standard. Similar letters represent no significant difference between those treatments (P<0.05).

FIGS. 12A-12B show bacterial population of Vibrio parahaemolyticus strain A3 in Tryptic Soy Broth containing 2% Sodium Chloride in presence of natural extracts, NE01, NE02, NE03, NE04, and NE05 at different concentrations. FIG. 12A represents growth curve at 24 hr and FIG. 12B represents a growth curve at 48 h.

FIG. 13 shows Vibrio parahaemolyticus (Strain A3) colony count after 48 h of culture in Tryptic Soy Broth containing 2% Sodium Chloride and different natural extracts, NE01, NE02, NE03, NE04, and NE05. Colony count was expressed as Colony Forming Unit/ml (CFU/ml) of culture.

FIG. 14 shows Vibrio parahaemolyticus (Strain A3) colony count after 48 hr. of culture in Tryptic Soy Broth containing 2% Sodium Chloride and natural extracts NE03, NE04, and NE05, and different combination of these three extracts. A=NE05+NE03 (1:1), B=NE03+NE04 (1:1), C=NE05+NE04 (1:1), D=NE03+NE04+NE05 (1:1:1) Colony count was expressed as Colony Forming Unit/ml (CFU/ml) of culture.

FIGS. 15A-15F shows scanning electron micrographs of Vibrio parahaemolyticus bacterial cell treated with subinhibitory concentration of natural extracts after 24 hr. incubation. (FIGS. 15A-15B) Untreated cells, (FIGS. 15C-15D) Cells treated with NE01 extract, (FIGS. 15E-15F) treated with NE02 (FIGS. 15A, 15C, and 15E), =Magnification×20000, A2, B2 & C2=Magnification×40000).

FIGS. 16A-16F shows scanning electron micrographs of Vibrio parahaemolyticus bacterial cell treated with subinhibitory concentration of natural extracts, NE03, NE04 and NE05 after 24 hr. incubation. (FIGS. 16A, 16C, and 16E=Magnification×20000, FIG. 16B, FIGS. 16D, and 16F=Magnification×40000). Red arrows indicate damaged bacterial cells.

FIGS. 17A-17D shows clinical signs of acute hepatopancreatic necrosis diseases (AHPND) in P. vannamei shrimp. (FIG. 17A) Healthy shrimp—unchallenged (Negative Control), (FIG. 17B) Clinical signs of AHPND-infected shrimp raised on a commercial diet, Positive Control. Pale, atrophied hepatopancreas (HP), and an empty stomach (ST) and midgut (MG) can be seen in the infected animal. (FIG. 17C) Shrimp fed diet containing NE05-10% and, (FIG. 17D) Shrimp fed diet containing NE05-20%. In FIG. 17C, HP appeared pale and gut empty, whereas in FIG. 17D, the HP looked brown colored and the gut remained full.

FIGS. 18A-18B shows (FIG. 18A) percentage survival (%) in P. vannamei shrimp upon challenge with acute hepatopancreatic necrosis disease (AHPND) at 7 days post-challenge. (FIG. 18B) Progression of shrimp survival over seven days after AHPND challenge. (+) Control=Positive Control, shrimp fed a commercial diet and challenged with AHPND, (−) Control=Negative Control, shrimp fed a commercial diet and remain unchallenged, NE05-10%=Shrimp fed a commercial diet containing NE05-10% (w/w), NE05-20%=Shrimp fed a commercial diet containing NE05-20% (w/w), Survival % are mean±SE of the results of three independent experiments, N=10 shrimps per replicate per treatment, and there were two replicates in each treatment.

FIGS. 19A-19H shows hematoxylin and eosin (H&E) stained histological sections of hepatopancreatic (HP) tissue of P. vannamei shrimp in different magnification. (FIGS. 19A-19B) Cross section of HP tissue from a healthy shrimp showing normal hepatopancreatic tubule with B, F, and R cells. (FIGS. 19C-19D) Cross section of HP tissue from a shrimp maintained on a commercial diet and challenged with AHPND, acute phase lesions displaying sloughing of HP tubule epithelial cells (White arrow). (FIGS. 19E-19F) Cross section of HP tissue from a shrimp maintained on a diet containing NE05-10% and challenged with AHPND. Terminal phase lesions displaying sloughing of necrotic HP tubule epithelial cells, sloughing of cells in the HP tubule lumens along with hemocytic infiltration and massive bacterial colonization (Red arrow). (FIGS. 19G-19H) Cross section of HP tissue from a shrimp maintained on a diet containing NE05-120% and challenged with AHPND. Hepatopancreatic tubule appear similar to healthy animals with B, F, and R cells, as in FIGS. 19A-19B. Scale bars=(FIGS. 19A, 19C, 19E, and 19G) 50 μm, (FIGS. 19B, 19D, 19F, and 19H) 100 μm.

FIG. 20 shows detection of pirA and pirB genes in AHPND-causing Vibrio parahaemolyticus by using Conventional PCR, L=1 kb DNA ladder; P=AHPND positive, N=Non-template control, Samples from Bioassay: NEO-10%, NE05-20%, (+) Control=Positive control, (−) Control=Negative control.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, ‘less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further embodiment. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

### General Definitions

Unless defined otherwise, technical and scientific terms used herein have the same meaning as commonly understood by one of ordinary skill in the art to which this disclosure pertains. Definitions of common terms and techniques in molecular biology may be found in Molecular Cloning: A Laboratory Manual, 2^{nd} edition (1989) (Sambrook, Fritsch, and Maniatis); Molecular Cloning: A Laboratory Manual, 4^{th} edition (2012) (Green and Sambrook); Current Protocols in Molecular Biology (1987) (F. M. Ausubel et al. eds.); the series Methods in Enzymology (Academic Press, Inc.): PCR 2: A Practical Approach (1995) (M. J. MacPherson, B. D. Hames, and G. R. Taylor eds.): Antibodies, A Laboratory Manual (1988) (Harlow and Lane, eds.): Antibodies A Laboratory Manual, 2^{nd} edition 2013 (E. A. Greenfield ed.); Animal Cell Culture (1987) (R.I. Freshney, ed.); Benjamin Lewin, Genes IX, published by Jones and Bartlet, 2008 (ISBN 0763752223); Kendrew et al. (eds.), The Encyclopedia of Molecular Biology, published by Blackwell Science Ltd., 1994 (ISBN 0632021829); Robert A. Meyers (ed.), Molecular Biology and Biotechnology: a Comprehensive Desk Reference, published by VCH Publishers, Inc., 1995 (ISBN 9780471185710); Singleton et al., Dictionary of Microbiology and Molecular Biology 2nd ed., J. Wiley & Sons (New York, N.Y. 1994), March, Advanced Organic Chemistry Reactions, Mechanisms and Structure 4th ed., John Wiley & Sons (New York, N.Y. 1992); and Marten H. Hofker and Jan van Deursen, Transgenic Mouse Methods and Protocols, 2^{nd} edition (2011).

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosed invention. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, a “biological sample” may contain whole cells and/or live cells and/or cell debris. The biological sample may contain (or be derived from) a “bodily fluid”. The present invention encompasses embodiments wherein the bodily fluid is selected from amniotic fluid, aqueous humour, vitreous humour, bile, blood serum, breast milk, cerebrospinal fluid, cerumen (earwax), chyle, chyme, endolymph, perilymph, exudates, feces, female ejaculate, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, urine, vaginal secretion, vomit and mixtures of one or more thereof. Biological samples include cell cultures, bodily fluids, cell cultures from bodily fluids. Bodily fluids may be obtained from a mammal organism, for example by puncture, or other collecting or sampling procedures.

The terms “subject,” “individual,” and “patient” are used interchangeably herein to refer to a vertebrate, including mammals, humans. Mammals include, but are not limited to, murines, simians, humans, farm animals, sport animals, and pets. In some embodiments, the subject is a crustacean, which includes, but is not limited to, shrimp. In some embodiments, the subject can be an organism that is susceptible to infection by a Vibrio spp. Tissues, cells and their progeny of a biological entity obtained in vivo or cultured in vitro are also encompassed.

As used herein, “active agent” or “active ingredient” refers to a substance, compound, or molecule, which is biologically active or otherwise, induces a biological or physiological effect on a subject to which it is administered to. In other words, “active agent” or “active ingredient” refers to a component or components of a composition to which the whole or part of the effect of the composition is attributed.

As used herein, “administering” refers to an administration that is environmental (i.e. distributed in the environment in which the subject lives or occupies for delivery to a subject) oral, topical, intravenous, subcutaneous, transcutaneous, transdermal, intramuscular, intra-joint, parenteral, intra-arteriole, intradermal, intraventricular, intraosseous, intraocular, intracranial, intraperitoneal, intralesional, intranasal, intracardiac, intraarticular, intracavernous, intrathecal, intravitreal, intracerebral, and intracerebroventricular, intratympanic, intracochlear, rectal, vaginal, by inhalation, by catheters, stents or via an implanted reservoir or other device that administers, either actively or passively (e.g. by diffusion) a composition the perivascular space and adventitia. For example, a medical device such as a stent can contain a composition or formulation disposed on its surface, which can then dissolve or be otherwise distributed to the surrounding tissue and cells. The term “parenteral” can include subcutaneous, intravenous, intramuscular, intra-articular, intra-synovial, intrasternal, intrathecal, intrahepatic, intralesional, and intracranial injections or infusion techniques. Administration can be directly to the subject and/or indirectly via an environmental administration. Environmental administration can occur without the subject present in the environment and can act directly on a target organism, such as a Vibrio spp., that is present in the environment.

As used herein, “anti-infective” refers to compounds or molecules that can either kill an infectious agent and/or inhibit it from spreading, growing, infecting cells, replicating, or otherwise inhibiting or eliminating a function or an activity of the infectious agents. Anti-infectives include, but are not limited to, antibiotics, antibacterials, antifungals, antivirals, and antiprotozoals.

The term “biocompatible”, as used herein, refers to a substance or object that performs its desired function when introduced into an organism without inducing significant inflammatory response, immunogenicity, or cytotoxicity to native cells, tissues, or organs, or to cells, tissues, or organs introduced with the substance or object. For example, a biocompatible product is a product that performs its desired function when introduced into an organism without inducing significant inflammatory response, immunogenicity, or cytotoxicity to native cells, tissues, or organs.

Biocompatibility, as used herein, can be quantified using the following in vivo biocompatibility assay. A material or product is considered biocompatible if it produces, in a test of biocompatibility related to immune system reaction, less than 50%, 45%, 40%, 35%, 30%, 25%, 20%, 15%, 10%, 8%, 6%, 5%, 4%, 3%, 2%, or 1% of the reaction, in the same test of biocompatibility, produced by a material or product the same as the test material or product except for a lack of the surface modification on the test material or product. Examples of useful biocompatibility tests include measuring and assessing cytotoxicity in cell culture, inflammatory response after implantation (such as by fluorescence detection of cathepsin activity), and immune system cells recruited to implant (for example, macrophages and neutrophils).

The term “molecular weight”, as used herein, can generally refer to the mass or average mass of a material. If a polymer or oligomer, the molecular weight can refer to the relative average chain length or relative chain mass of the bulk polymer. In practice, the molecular weight of polymers and oligomers can be estimated or characterized in various ways including gel permeation chromatography (GPC) or capillary viscometry. GPC molecular weights are reported as the weight-average molecular weight (Mw) as opposed to the number-average molecular weight (Mn). Capillary viscometry provides estimates of molecular weight as the inherent viscosity determined from a dilute polymer solution using a particular set of concentration, temperature, and solvent conditions.

As used herein, “non-human mammal” or “non-human animal” refers to any mammal or animal, respectively, that is not a human.

As used herein, “preventative” and “prevent” refers to hindering or stopping a disease or condition before it occurs, even if undiagnosed, or while the disease or condition is still in the sub-clinical phase.

As used herein, “substantial” and “substantially,” specify an amount of between 95% and 100%, inclusive, between 96% and 100%, inclusive, between 97% and 100%, inclusive, between 98% 100%, inclusive, or between 99% 100%, inclusive.

As used herein, “substantially free” can mean an object species is present at non-detectable or trace levels so as not to interfere with the properties of a composition or process.

As used interchangeably herein, the terms “sufficient” and “effective,” can refer to an amount (e.g. mass, volume, dosage, concentration, and/or time period) needed to achieve one or more desired result(s). For example, a therapeutically effective amount refers to an amount needed to achieve one or more therapeutic effects. The term “effective amount” as it relates to any of the plant extracts, plant extract component, or formulation as a whole, refers to the amount that is effective to a) treat an infection caused by a Vibrio spp. and/or AHPND in a subject; b) prevent an infection caused by a Vibrio spp and/or AHPND in a subject; c) reduce, inhibit, and/or eliminate pathogenicity of a Vibrio spp.; d) reduce, inhibit, and/or eliminate growth and/or development of a Vibrio spp.; e) kill a Vibrio spp. organism, and/or f) increase the survivability of a subject when exposed to or infected with a Vibrio spp.

Vibrio spp. refers to organism of the genus Vibrio, which are gram negative bacteria possessing a curved-rod (comma) shape. Vibrio spp. are typically found in salt water. Vibrio spp include, but are not limited to, V. adaptatus, V. aerogenes, V. aestivus, V. aestuarianus, V. agarivorans, V. albensis, V. alfacsensis, V. alginolyticus, V. anguillarum, V. areninigrae, V. artabrorum, V. atlanticus, V. atypicus, V. azureus, V. brasiliensis, V. bubulus, V. calviensis, V. campbellii, V. casei, V. chagasii, V. cholerae, V. cincinnatiensis, V. coralliilyticus, V. crassostreae, V. cyclitrophicus, V. diabolicus, V. diazotrophicus, V. ezurae, V. fluvialis, V. fortis, V. furnissii, V. gallicus, V. gazogenes, V. gigantis, V. halioticoli, V. harveyi, V. hepatarius, V. hippocampi, V. hispanicus, V. ichthyoenteri, V. indicus, V. kanaloae, V. lentus, V. litoralis, V. logei, V. mediterranei, V. metschnikovii, V. mimicus, V. mytili, V. natriegens, V. navarrensis, V. neonates, V. neptunius, V. nereis, V. nigripulchritudo, V. ordalii, V. orientalis, V. pacinii, V. parahaemolyticus, V. pectenicida, V. penaeicida, V. pomeroyi, V. ponticus, V. proteolyticus, V. rotiferianus, V. ruber, V. rumoiensis, V. salmonicida, V. scophthalmi. V. splendidus, V. superstes, V. tapetis, V. tasmaniensis, V. tubiashii, V. vulnificus, V. wodanis, V. xuii. Some Vibrio spp. are pathogenic. Pathogenic Vibrio spp include, but are not limited to, Pathogenic Vibrio species include V. cholerae (the causative agent of cholera), V. parahaemolyticus, and V. vulnificus. V. cholerae is generally transmitted by contaminated water.

Various embodiments are described hereinafter. It should be noted that the specific embodiments are not intended as an exhaustive description or as a limitation to the broader embodiments discussed herein. One embodiment described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

All publications, published patent documents, and patent applications cited herein are hereby incorporated by reference to the same extent as though each individual publication, published patent document, or patent application was specifically and individually indicated as being incorporated by reference.

### Overview

Acute hepatopancreatic necrosis disease (AHPND, initially referenced to as early mortality syndrome, EMS) is a deadly shrimp disease caused by particular Vibrio spp. The disease first emerged in China in 2009 and has rapidly spread throughout Southeast Asia to Vietnam, Malaysia, Thailand and reached Mexico in Latin America. The impact of AHPND in shrimp farming at a global scale has been catastrophic with an estimated global loss of $1 billion per year. Given the economic impact, there exists a need for approaches to control infection by Vibrio spp.

The clinical signs of AHPND include lethargy, spiral swimming, and empty or interrupted digestive tracts. Infected shrimp display an abnormal hepatopancreas (HP) (emaciated, undersized distended, pale, or black coloration) and sink to the pond bottom before dying (Lightner et al., 2013; Tran et al., 2013). Generally, AHPND outbreak occurs within the initial 20-30 days after stocking a pond with post-larvae (PL), although there is a report that the disease can occur in late stage juveniles even at 94-day post-culture (de la Pefia et al. 2015). In the terminal stage, massive secondary infections occur. This is characterized by a massive accumulation of hemocytes and the formation of melanized granulomas followed by infection in tubule lumen with opportunistic bacteria. It is difficult to distinguish such manifestations in terminal stage in shrimps due to severe infections by non-AHPND causing bacteria (Hong et al., 2016).

The main histological features of AHPND in the early to middle stage of the disease are progressive degeneration of HP tubule from medial to distal end of the tubule. Prominent necrosis & sloughing of the tubule epithelial cells is observed with no detectable causative pathogen (Loc Tran et al., 2013)(Lightner et al., n.d.). At the initial stages of AHPND, the disease is characterized by medial to distal dysfunction of HP tubule cells such as B (blister like), F (fibrillar), and R (resorptive) cells, prominent karyomegaly, and lack of mitotic activity in E cells (embryonic). In the terminal stage, massive secondary infections occur. This is characterized by a massive accumulation of hemocytes and the formation of melanized granulomas followed by infection in tubule lumen with opportunistic bacteria. It is difficult to distinguish such manifestations in terminal stage in shrimps due to severe infections by non-AHPND causing bacteria (Hong et al., 2016).

The etiologic agent of AHPND was originally shown to be a specific strain of Vibrio parahaemolyticus called the AHPND-causing V. parahaemolyticus (VPAHPN) (Han et al., 2017; Lee et al., 2015). Vibrio parahaemolyticus, is a Gram-negative, halophilic, rod-shaped bacterium which is widely present in marine environments. Vibrio parahaemolyticus becomes virulent after acquiring a plasmid (pVA1) that expresses a deadly binary toxin PirVP (Dong et al., 2017). The toxin consists of two subunits, PirA and PirB, and is homologous to the Pir (Photorhabdus insect-related) binary toxin (Dong et al., 2017). The plasmid pVA1 that carries the toxin genes is ˜70 kb in size and was found to contain a cluster of genes related to conjugative transfer indicating that the plasmid may potentially be able to transfer not only among V. parahaemolyticus strains, but also to different bacterial species (Lee et al., 2015). The tertiary structure of PirA and PirB toxins have similarity to Cry insecticidal toxin-like protein that has a pore-forming activity leading to cell deaths in insects (Prachumwat et al., 2019). It is believed that AHPND-causing Vibrio parahaemolyticus colonizes shrimp stomach and releases binary toxin which enters HP via the gastric sieve. The molecular mechanism by which toxins induce cell necrosis and severe sloughing in hepatopancreas tissue in shrimp is yet to be determined.

Since the initial report, several other Vibrio species including V. owensii, V. campbelli, V. harveyi and Vibrio punensis have been reported that cause AHPND. Currently, there is no therapeutic against AHPND and the use of antibiotics is not feasible due to potential residues in commodity shrimp and the development of drug-resistant bacteria. As such there exists a need for treatment options against AHPND suitable for use in at least aquaculture.

With that said, described herein various embodiments of a formulation that can be composed of an amount of one or more plant extracts selected from the group of cinnamon oil, citral, cavacrol, oregano, and trans cinnamaldehyde. In some embodiments, the formulation can be effective to treat or prevent AHPND in a subject to which it is delivered. In some embodiments, the formulation is anti-infective. In some embodiments, the formulation can be effective to treat or prevent an infection caused by a Vibrio spp. in a subject to which it is delivered. In some embodiments, the formulation can be effective to reduce, inhibit, and/or eliminate pathogenicity of a Vibrio spp., such as in a subject or environment to which it is delivered. In some embodiments, the formulation can be effective to reduce, inhibit, and/or eliminate growth and/or development of a Vibrio spp., such as in a subject or environment to which it is delivered. In some embodiments, the formulation can be effective to kill a Vibrio spp., such as in a subject or environment to which it is delivered. In some embodiments, the formulation can be formulated as a feed additive. In some embodiments, the formulation can be formulated as a water additive. Also described herein are methods of administering a formulation described herein to a subject, such as a shrimp. Also described herein are methods of treating or preventing Vibrio spp. infection or disease, such as AHPND, in a subject, such as a shrimp, that includes administering a formulation described herein to the subject. Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

### Formulations

Described in several embodiments herein are formulations that contain an amount of one or more plant extracts selected from the group of cinnamon oil (CO), citral, cavacrol, oregano oil (OO), and trans cinnamaldehyde (TC) and combinations thereof. These extracts do not necessarily exist in nature together. In some embodiments, this plant extract component is the active agent or primary active agent in the formulation that provides the formulation's therapeutic benefits, such as against, a Vibrio spp. As described in greater detail herein, the formulations can optionally contain secondary or auxiliary active agents in addition to the plant extract primary active agents, carriers, excipients, and/or other ingredients.

### Plant Extracts

Described herein are formulations that can contain a plant extract component composed of an amount of one or more plant extracts selected from the group of cinnamon oil (CO), citral, cavacrol, oregano oil (OO), and trans cinnamaldehyde (TC) and combinations thereof. In some embodiments, the formulation contains a suitable diluent or carrier. In some embodiments, the amount of each plant extract can be an effective amount. In some embodiments, the formulation can be effective to treat or prevent an infection caused by a Vibrio spp in a subject to which it is delivered. In some embodiments, the formulation can be effective to reduce, inhibit, and/or eliminate pathogenicity of a Vibrio spp., such as in a subject or environment to which it is delivered. In some embodiments, the formulation can be effective to reduce, inhibit, and/or eliminate growth and/or development of a Vibrio spp., such as in a subject or environment to which it is delivered. In some embodiments, the formulation can be effective to kill a Vibrio spp., such as in a subject or environment to which it is delivered.

In some embodiments, the formulation contains at least an amount of CO. In some embodiments, the formulation contains an effective amount of CO. In some embodiments, the formulation only contains CO. In some embodiments, the formulation only contains CO as the active ingredient. In some embodiments, the formulation only contains CO and a suitable diluent or carrier.

In some embodiments, the formulation can contain about 1 to 100 percent CO (v/v, w/v, or wt. %). In some embodiments, the formulation contains about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent CO (v/v, w/v, or wt. %). In some embodiments, the formulation contains about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent CO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent CO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent CO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent CO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5 to/or 30 CO (v/v, w/v, or wt. %).

In some embodiments, the formulation can contain about 0.001 to about 1% (v/v) CO. In some embodiments, the formulation can contain about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.101, 0.102, 0.103, 0.104, 0.105, 0.106, 0.107, 0.108, 0.109, 0.11, 0.111, 0.112, 0.113, 0.114, 0.115, 0.116, 0.117, 0.118, 0.119, 0.12, 0.121, 0.122, 0.123, 0.124, 0.125, 0.126, 0.127, 0.128, 0.129, 0.13, 0.131, 0.132, 0.133, 0.134, 0.135, 0.136, 0.137, 0.138, 0.139, 0.14, 0.141, 0.142, 0.143, 0.144, 0.145, 0.146, 0.147, 0.148, 0.149, 0.15, 0.151, 0.152, 0.153, 0.154, 0.155, 0.156, 0.157, 0.158, 0.159, 0.16, 0.161, 0.162, 0.163, 0.164, 0.165, 0.166, 0.167, 0.168, 0.169, 0.17, 0.171, 0.172, 0.173, 0.174, 0.175, 0.176, 0.177, 0.178, 0.179, 0.18, 0.181, 0.182, 0.183, 0.184, 0.185, 0.186, 0.187, 0.188, 0.189, 0.19, 0.191, 0.192, 0.193, 0.194, 0.195, 0.196, 0.197, 0.198, 0.199, 0.2, 0.201, 0.202, 0.203, 0.204, 0.205, 0.206, 0.207, 0.208, 0.209, 0.21, 0.211, 0.212, 0.213, 0.214, 0.215, 0.216, 0.217, 0.218, 0.219, 0.22, 0.221, 0.222, 0.223, 0.224, 0.225, 0.226, 0.227, 0.228, 0.229, 0.23, 0.231, 0.232, 0.233, 0.234, 0.235, 0.236, 0.237, 0.238, 0.239, 0.24, 0.241, 0.242, 0.243, 0.244, 0.245, 0.246, 0.247, 0.248, 0.249, 0.25, 0.251, 0.252, 0.253, 0.254, 0.255, 0.256, 0.257, 0.258, 0.259, 0.26, 0.261, 0.262, 0.263, 0.264, 0.265, 0.266, 0.267, 0.268, 0.269, 0.27, 0.271, 0.272, 0.273, 0.274, 0.275, 0.276, 0.277, 0.278, 0.279, 0.28, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, 0.499, 0.5, 0.501, 0.502, 0.503, 0.504, 0.505, 0.506, 0.507, 0.508, 0.509, 0.51, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.89, 0.891, 0.892, 0.893, 0.894, 0.895, 0.896, 0.897, 0.898, 0.899, 0.9, 0.901, 0.902, 0.903, 0.904, 0.905, 0.906, 0.907, 0.908, 0.909, 0.91, 0.911, 0.912, 0.913, 0.914, 0.915, 0.916, 0.917, 0.918, 0.919, 0.92, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.94, 0.941, 0.942, 0.943, 0.944, 0.945, 0.946, 0.947, 0.948, 0.949, 0.95, 0.951, 0.952, 0.953, 0.954, 0.955, 0.956, 0.957, 0.958, 0.959, 0.96, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.98, 0.981, 0.982, 0.983, 0.984, 0.985, 0.986, 0.987, 0.988, 0.989, 0.99, 0.991, 0.992, 0.993, 0.994, 0.995, 0.996, 0.997, 0.998, 0.999%, or 1% CO or any range therein. The formulation can contain about 0.001% to about 0.1% (v/v) CO. In some embodiments, the formulation can contain about 0.015% v/v CO. In some embodiments, the effective amount of CO is about 0.015% v/v.

In some embodiments, the formulation contains at least an amount of citral. In some embodiments, the formulation contains an effective amount of citral. In some embodiments, the formulation only contains citral. In some embodiments, the formulation only contains citral as the active ingredient. In some embodiments, the formulation only contains citral and a suitable diluent or carrier.

In some embodiments, the formulation can contain about 1 to 100 percent citral (v/v, w/v, or wt. %). In some embodiments, the formulation contains about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent citral (v/v, w/v, or wt. %). In some embodiments, the formulation contains about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent citral (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent citral (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent citral (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent citral (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5 to/or 30 citral (v/v, w/v, or wt. %).

In some embodiments, the formulation contains about 0.001 to about 1% (v/v) citral. In some embodiments, the formulation can contain about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.101, 0.102, 0.103, 0.104, 0.105, 0.106, 0.107, 0.108, 0.109, 0.11, 0.111, 0.112, 0.113, 0.114, 0.115, 0.116, 0.117, 0.118, 0.119, 0.12, 0.121, 0.122, 0.123, 0.124, 0.125, 0.126, 0.127, 0.128, 0.129, 0.13, 0.131, 0.132, 0.133, 0.134, 0.135, 0.136, 0.137, 0.138, 0.139, 0.14, 0.141, 0.142, 0.143, 0.144, 0.145, 0.146, 0.147, 0.148, 0.149, 0.15, 0.151, 0.152, 0.153, 0.154, 0.155, 0.156, 0.157, 0.158, 0.159, 0.16, 0.161, 0.162, 0.163, 0.164, 0.165, 0.166, 0.167, 0.168, 0.169, 0.17, 0.171, 0.172, 0.173, 0.174, 0.175, 0.176, 0.177, 0.178, 0.179, 0.18, 0.181, 0.182, 0.183, 0.184, 0.185, 0.186, 0.187, 0.188, 0.189, 0.19, 0.191, 0.192, 0.193, 0.194, 0.195, 0.196, 0.197, 0.198, 0.199, 0.2, 0.201, 0.202, 0.203, 0.204, 0.205, 0.206, 0.207, 0.208, 0.209, 0.21, 0.211, 0.212, 0.213, 0.214, 0.215, 0.216, 0.217, 0.218, 0.219, 0.22, 0.221, 0.222, 0.223, 0.224, 0.225, 0.226, 0.227, 0.228, 0.229, 0.23, 0.231, 0.232, 0.233, 0.234, 0.235, 0.236, 0.237, 0.238, 0.239, 0.24, 0.241, 0.242, 0.243, 0.244, 0.245, 0.246, 0.247, 0.248, 0.249, 0.25, 0.251, 0.252, 0.253, 0.254, 0.255, 0.256, 0.257, 0.258, 0.259, 0.26, 0.261, 0.262, 0.263, 0.264, 0.265, 0.266, 0.267, 0.268, 0.269, 0.27, 0.271, 0.272, 0.273, 0.274, 0.275, 0.276, 0.277, 0.278, 0.279, 0.28, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, 0.499, 0.5, 0.501, 0.502, 0.503, 0.504, 0.505, 0.506, 0.507, 0.508, 0.509, 0.51, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.89, 0.891, 0.892, 0.893, 0.894, 0.895, 0.896, 0.897, 0.898, 0.899, 0.9, 0.901, 0.902, 0.903, 0.904, 0.905, 0.906, 0.907, 0.908, 0.909, 0.91, 0.911, 0.912, 0.913, 0.914, 0.915, 0.916, 0.917, 0.918, 0.919, 0.92, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.94, 0.941, 0.942, 0.943, 0.944, 0.945, 0.946, 0.947, 0.948, 0.949, 0.95, 0.951, 0.952, 0.953, 0.954, 0.955, 0.956, 0.957, 0.958, 0.959, 0.96, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.98, 0.981, 0.982, 0.983, 0.984, 0.985, 0.986, 0.987, 0.988, 0.989, 0.99, 0.991, 0.992, 0.993, 0.994, 0.995, 0.996, 0.997, 0.998, 0.999%, or 1% citral or any range therein. The formulation can contain about 0.001% to about 0.1% (v/v) citral. In some embodiments, the formulation can contain about 0.015% v/v citral. In some embodiments, the effective amount of citral is about 0.015% v/v.

In some embodiments, the formulation contains at least an amount of cavacrol. In some embodiments, the formulation contains an effective amount of cavacrol. In some embodiments, the formulation only contains cavacrol. In some embodiments, the formulation only contains cavacrol as the active ingredient. In some embodiments, the formulation only contains cavacrol and a suitable diluent or carrier.

In some embodiments, the formulation can contain about 1 to 100 percent cavacrol (v/v, w/v, or wt. %). In some embodiments, the formulation contains about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent cavacrol (v/v, w/v, or wt. %). In some embodiments, the formulation contains about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent cavacrol (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent cavacrol (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent cavacrol (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent cavacrol (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5 to/or 30 cavacrol (v/v, w/v, or wt. %).

In some embodiments, the formulation contains about 0.001 to about 1% (v/v) cavacrol. In some embodiments, the formulation can contain about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.101, 0.102, 0.103, 0.104, 0.105, 0.106, 0.107, 0.108, 0.109, 0.11, 0.111, 0.112, 0.113, 0.114, 0.115, 0.116, 0.117, 0.118, 0.119, 0.12, 0.121, 0.122, 0.123, 0.124, 0.125, 0.126, 0.127, 0.128, 0.129, 0.13, 0.131, 0.132, 0.133, 0.134, 0.135, 0.136, 0.137, 0.138, 0.139, 0.14, 0.141, 0.142, 0.143, 0.144, 0.145, 0.146, 0.147, 0.148, 0.149, 0.15, 0.151, 0.152, 0.153, 0.154, 0.155, 0.156, 0.157, 0.158, 0.159, 0.16, 0.161, 0.162, 0.163, 0.164, 0.165, 0.166, 0.167, 0.168, 0.169, 0.17, 0.171, 0.172, 0.173, 0.174, 0.175, 0.176, 0.177, 0.178, 0.179, 0.18, 0.181, 0.182, 0.183, 0.184, 0.185, 0.186, 0.187, 0.188, 0.189, 0.19, 0.191, 0.192, 0.193, 0.194, 0.195, 0.196, 0.197, 0.198, 0.199, 0.2, 0.201, 0.202, 0.203, 0.204, 0.205, 0.206, 0.207, 0.208, 0.209, 0.21, 0.211, 0.212, 0.213, 0.214, 0.215, 0.216, 0.217, 0.218, 0.219, 0.22, 0.221, 0.222, 0.223, 0.224, 0.225, 0.226, 0.227, 0.228, 0.229, 0.23, 0.231, 0.232, 0.233, 0.234, 0.235, 0.236, 0.237, 0.238, 0.239, 0.24, 0.241, 0.242, 0.243, 0.244, 0.245, 0.246, 0.247, 0.248, 0.249, 0.25, 0.251, 0.252, 0.253, 0.254, 0.255, 0.256, 0.257, 0.258, 0.259, 0.26, 0.261, 0.262, 0.263, 0.264, 0.265, 0.266, 0.267, 0.268, 0.269, 0.27, 0.271, 0.272, 0.273, 0.274, 0.275, 0.276, 0.277, 0.278, 0.279, 0.28, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, 0.499, 0.5, 0.501, 0.502, 0.503, 0.504, 0.505, 0.506, 0.507, 0.508, 0.509, 0.51, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.89, 0.891, 0.892, 0.893, 0.894, 0.895, 0.896, 0.897, 0.898, 0.899, 0.9, 0.901, 0.902, 0.903, 0.904, 0.905, 0.906, 0.907, 0.908, 0.909, 0.91, 0.911, 0.912, 0.913, 0.914, 0.915, 0.916, 0.917, 0.918, 0.919, 0.92, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.94, 0.941, 0.942, 0.943, 0.944, 0.945, 0.946, 0.947, 0.948, 0.949, 0.95, 0.951, 0.952, 0.953, 0.954, 0.955, 0.956, 0.957, 0.958, 0.959, 0.96, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.98, 0.981, 0.982, 0.983, 0.984, 0.985, 0.986, 0.987, 0.988, 0.989, 0.99, 0.991, 0.992, 0.993, 0.994, 0.995, 0.996, 0.997, 0.998, 0.999%, or 1% cavacrol or any range therein. The formulation can contain about 0.001% to about 0.5% (v/v) cavacrol. In some embodiments, the formulation can contain about 0.075% v/v cavacrol. In some embodiments, the effective amount of cavacrol is about 0.075% v/v.

In some embodiments, the formulation contains at least an amount of OO. In some embodiments, the formulation contains an effective amount of OO. In some embodiments, the formulation only contains OO. In some embodiments, the formulation only contains OO as the active ingredient. In some embodiments, the formulation only contains OO and a suitable diluent or carrier.

In some embodiments, the formulation can contain about 1 to 100 percent OO (v/v, w/v, or wt. %). In some embodiments, the formulation contains about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent OO (v/v, w/v, or wt. %). In some embodiments, the formulation contains about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent OO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent OO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent OO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent OO (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5 to/or 30 OO (v/v, w/v, or wt. %).

In some embodiments, the formulation contains about 0.001 to about 1% (v/v) OO. In some embodiments, the formulation can contain about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.101, 0.102, 0.103, 0.104, 0.105, 0.106, 0.107, 0.108, 0.109, 0.11, 0.111, 0.112, 0.113, 0.114, 0.115, 0.116, 0.117, 0.118, 0.119, 0.12, 0.121, 0.122, 0.123, 0.124, 0.125, 0.126, 0.127, 0.128, 0.129, 0.13, 0.131, 0.132, 0.133, 0.134, 0.135, 0.136, 0.137, 0.138, 0.139, 0.14, 0.141, 0.142, 0.143, 0.144, 0.145, 0.146, 0.147, 0.148, 0.149, 0.15, 0.151, 0.152, 0.153, 0.154, 0.155, 0.156, 0.157, 0.158, 0.159, 0.16, 0.161, 0.162, 0.163, 0.164, 0.165, 0.166, 0.167, 0.168, 0.169, 0.17, 0.171, 0.172, 0.173, 0.174, 0.175, 0.176, 0.177, 0.178, 0.179, 0.18, 0.181, 0.182, 0.183, 0.184, 0.185, 0.186, 0.187, 0.188, 0.189, 0.19, 0.191, 0.192, 0.193, 0.194, 0.195, 0.196, 0.197, 0.198, 0.199, 0.2, 0.201, 0.202, 0.203, 0.204, 0.205, 0.206, 0.207, 0.208, 0.209, 0.21, 0.211, 0.212, 0.213, 0.214, 0.215, 0.216, 0.217, 0.218, 0.219, 0.22, 0.221, 0.222, 0.223, 0.224, 0.225, 0.226, 0.227, 0.228, 0.229, 0.23, 0.231, 0.232, 0.233, 0.234, 0.235, 0.236, 0.237, 0.238, 0.239, 0.24, 0.241, 0.242, 0.243, 0.244, 0.245, 0.246, 0.247, 0.248, 0.249, 0.25, 0.251, 0.252, 0.253, 0.254, 0.255, 0.256, 0.257, 0.258, 0.259, 0.26, 0.261, 0.262, 0.263, 0.264, 0.265, 0.266, 0.267, 0.268, 0.269, 0.27, 0.271, 0.272, 0.273, 0.274, 0.275, 0.276, 0.277, 0.278, 0.279, 0.28, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, 0.499, 0.5, 0.501, 0.502, 0.503, 0.504, 0.505, 0.506, 0.507, 0.508, 0.509, 0.51, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.89, 0.891, 0.892, 0.893, 0.894, 0.895, 0.896, 0.897, 0.898, 0.899, 0.9, 0.901, 0.902, 0.903, 0.904, 0.905, 0.906, 0.907, 0.908, 0.909, 0.91, 0.911, 0.912, 0.913, 0.914, 0.915, 0.916, 0.917, 0.918, 0.919, 0.92, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.94, 0.941, 0.942, 0.943, 0.944, 0.945, 0.946, 0.947, 0.948, 0.949, 0.95, 0.951, 0.952, 0.953, 0.954, 0.955, 0.956, 0.957, 0.958, 0.959, 0.96, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.98, 0.981, 0.982, 0.983, 0.984, 0.985, 0.986, 0.987, 0.988, 0.989, 0.99, 0.991, 0.992, 0.993, 0.994, 0.995, 0.996, 0.997, 0.998, 0.999%, or 1% OO or any range therein. The formulation can contain about 0.001% to about 0.5% (v/v) OO. In some embodiments, the formulation can contain about 0.075% v/v OO. In some embodiments, the effective amount of OO is about 0.075% v/v.

In some embodiments, the formulation contains at least an amount of TC. In some embodiments, the formulation contains an effective amount of TC. In some embodiments, the formulation only contains TC. In some embodiments, the formulation only contains TC as the active ingredient. In some embodiments, the formulation only contains TC and a suitable diluent or carrier.

In some embodiments, the formulation can contain about 1 to 100 percent TC (v/v, w/v, or wt. %). In some embodiments, the formulation contains about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent TC (v/v, w/v, or wt. %). In some embodiments, the formulation contains about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent TC (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent TC (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent TC (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent TC (v/v, w/v, or wt. %). In some embodiments, the formulation contains about 20, 20.5, 21, 21.5, 22, 22.5, 23, 23.5, 24, 24.5, 25, 25.5, 26, 26.5, 27, 27.5, 28, 28.5, 29, 29.5 to/or 30 TC (v/v, w/v, or wt. %).

In some embodiments, the formulation can contain about 0.001 to about 1% (v/v) TC. In some embodiments, the formulation can contain about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.101, 0.102, 0.103, 0.104, 0.105, 0.106, 0.107, 0.108, 0.109, 0.11, 0.111, 0.112, 0.113, 0.114, 0.115, 0.116, 0.117, 0.118, 0.119, 0.12, 0.121, 0.122, 0.123, 0.124, 0.125, 0.126, 0.127, 0.128, 0.129, 0.13, 0.131, 0.132, 0.133, 0.134, 0.135, 0.136, 0.137, 0.138, 0.139, 0.14, 0.141, 0.142, 0.143, 0.144, 0.145, 0.146, 0.147, 0.148, 0.149, 0.15, 0.151, 0.152, 0.153, 0.154, 0.155, 0.156, 0.157, 0.158, 0.159, 0.16, 0.161, 0.162, 0.163, 0.164, 0.165, 0.166, 0.167, 0.168, 0.169, 0.17, 0.171, 0.172, 0.173, 0.174, 0.175, 0.176, 0.177, 0.178, 0.179, 0.18, 0.181, 0.182, 0.183, 0.184, 0.185, 0.186, 0.187, 0.188, 0.189, 0.19, 0.191, 0.192, 0.193, 0.194, 0.195, 0.196, 0.197, 0.198, 0.199, 0.2, 0.201, 0.202, 0.203, 0.204, 0.205, 0.206, 0.207, 0.208, 0.209, 0.21, 0.211, 0.212, 0.213, 0.214, 0.215, 0.216, 0.217, 0.218, 0.219, 0.22, 0.221, 0.222, 0.223, 0.224, 0.225, 0.226, 0.227, 0.228, 0.229, 0.23, 0.231, 0.232, 0.233, 0.234, 0.235, 0.236, 0.237, 0.238, 0.239, 0.24, 0.241, 0.242, 0.243, 0.244, 0.245, 0.246, 0.247, 0.248, 0.249, 0.25, 0.251, 0.252, 0.253, 0.254, 0.255, 0.256, 0.257, 0.258, 0.259, 0.26, 0.261, 0.262, 0.263, 0.264, 0.265, 0.266, 0.267, 0.268, 0.269, 0.27, 0.271, 0.272, 0.273, 0.274, 0.275, 0.276, 0.277, 0.278, 0.279, 0.28, 0.281, 0.282, 0.283, 0.284, 0.285, 0.286, 0.287, 0.288, 0.289, 0.29, 0.291, 0.292, 0.293, 0.294, 0.295, 0.296, 0.297, 0.298, 0.299, 0.3, 0.301, 0.302, 0.303, 0.304, 0.305, 0.306, 0.307, 0.308, 0.309, 0.31, 0.311, 0.312, 0.313, 0.314, 0.315, 0.316, 0.317, 0.318, 0.319, 0.32, 0.321, 0.322, 0.323, 0.324, 0.325, 0.326, 0.327, 0.328, 0.329, 0.33, 0.331, 0.332, 0.333, 0.334, 0.335, 0.336, 0.337, 0.338, 0.339, 0.34, 0.341, 0.342, 0.343, 0.344, 0.345, 0.346, 0.347, 0.348, 0.349, 0.35, 0.351, 0.352, 0.353, 0.354, 0.355, 0.356, 0.357, 0.358, 0.359, 0.36, 0.361, 0.362, 0.363, 0.364, 0.365, 0.366, 0.367, 0.368, 0.369, 0.37, 0.371, 0.372, 0.373, 0.374, 0.375, 0.376, 0.377, 0.378, 0.379, 0.38, 0.381, 0.382, 0.383, 0.384, 0.385, 0.386, 0.387, 0.388, 0.389, 0.39, 0.391, 0.392, 0.393, 0.394, 0.395, 0.396, 0.397, 0.398, 0.399, 0.4, 0.401, 0.402, 0.403, 0.404, 0.405, 0.406, 0.407, 0.408, 0.409, 0.41, 0.411, 0.412, 0.413, 0.414, 0.415, 0.416, 0.417, 0.418, 0.419, 0.42, 0.421, 0.422, 0.423, 0.424, 0.425, 0.426, 0.427, 0.428, 0.429, 0.43, 0.431, 0.432, 0.433, 0.434, 0.435, 0.436, 0.437, 0.438, 0.439, 0.44, 0.441, 0.442, 0.443, 0.444, 0.445, 0.446, 0.447, 0.448, 0.449, 0.45, 0.451, 0.452, 0.453, 0.454, 0.455, 0.456, 0.457, 0.458, 0.459, 0.46, 0.461, 0.462, 0.463, 0.464, 0.465, 0.466, 0.467, 0.468, 0.469, 0.47, 0.471, 0.472, 0.473, 0.474, 0.475, 0.476, 0.477, 0.478, 0.479, 0.48, 0.481, 0.482, 0.483, 0.484, 0.485, 0.486, 0.487, 0.488, 0.489, 0.49, 0.491, 0.492, 0.493, 0.494, 0.495, 0.496, 0.497, 0.498, 0.499, 0.5, 0.501, 0.502, 0.503, 0.504, 0.505, 0.506, 0.507, 0.508, 0.509, 0.51, 0.511, 0.512, 0.513, 0.514, 0.515, 0.516, 0.517, 0.518, 0.519, 0.52, 0.521, 0.522, 0.523, 0.524, 0.525, 0.526, 0.527, 0.528, 0.529, 0.53, 0.531, 0.532, 0.533, 0.534, 0.535, 0.536, 0.537, 0.538, 0.539, 0.54, 0.541, 0.542, 0.543, 0.544, 0.545, 0.546, 0.547, 0.548, 0.549, 0.55, 0.551, 0.552, 0.553, 0.554, 0.555, 0.556, 0.557, 0.558, 0.559, 0.56, 0.561, 0.562, 0.563, 0.564, 0.565, 0.566, 0.567, 0.568, 0.569, 0.57, 0.571, 0.572, 0.573, 0.574, 0.575, 0.576, 0.577, 0.578, 0.579, 0.58, 0.581, 0.582, 0.583, 0.584, 0.585, 0.586, 0.587, 0.588, 0.589, 0.59, 0.591, 0.592, 0.593, 0.594, 0.595, 0.596, 0.597, 0.598, 0.599, 0.6, 0.601, 0.602, 0.603, 0.604, 0.605, 0.606, 0.607, 0.608, 0.609, 0.61, 0.611, 0.612, 0.613, 0.614, 0.615, 0.616, 0.617, 0.618, 0.619, 0.62, 0.621, 0.622, 0.623, 0.624, 0.625, 0.626, 0.627, 0.628, 0.629, 0.63, 0.631, 0.632, 0.633, 0.634, 0.635, 0.636, 0.637, 0.638, 0.639, 0.64, 0.641, 0.642, 0.643, 0.644, 0.645, 0.646, 0.647, 0.648, 0.649, 0.65, 0.651, 0.652, 0.653, 0.654, 0.655, 0.656, 0.657, 0.658, 0.659, 0.66, 0.661, 0.662, 0.663, 0.664, 0.665, 0.666, 0.667, 0.668, 0.669, 0.67, 0.671, 0.672, 0.673, 0.674, 0.675, 0.676, 0.677, 0.678, 0.679, 0.68, 0.681, 0.682, 0.683, 0.684, 0.685, 0.686, 0.687, 0.688, 0.689, 0.69, 0.691, 0.692, 0.693, 0.694, 0.695, 0.696, 0.697, 0.698, 0.699, 0.7, 0.701, 0.702, 0.703, 0.704, 0.705, 0.706, 0.707, 0.708, 0.709, 0.71, 0.711, 0.712, 0.713, 0.714, 0.715, 0.716, 0.717, 0.718, 0.719, 0.72, 0.721, 0.722, 0.723, 0.724, 0.725, 0.726, 0.727, 0.728, 0.729, 0.73, 0.731, 0.732, 0.733, 0.734, 0.735, 0.736, 0.737, 0.738, 0.739, 0.74, 0.741, 0.742, 0.743, 0.744, 0.745, 0.746, 0.747, 0.748, 0.749, 0.75, 0.751, 0.752, 0.753, 0.754, 0.755, 0.756, 0.757, 0.758, 0.759, 0.76, 0.761, 0.762, 0.763, 0.764, 0.765, 0.766, 0.767, 0.768, 0.769, 0.77, 0.771, 0.772, 0.773, 0.774, 0.775, 0.776, 0.777, 0.778, 0.779, 0.78, 0.781, 0.782, 0.783, 0.784, 0.785, 0.786, 0.787, 0.788, 0.789, 0.79, 0.791, 0.792, 0.793, 0.794, 0.795, 0.796, 0.797, 0.798, 0.799, 0.8, 0.801, 0.802, 0.803, 0.804, 0.805, 0.806, 0.807, 0.808, 0.809, 0.81, 0.811, 0.812, 0.813, 0.814, 0.815, 0.816, 0.817, 0.818, 0.819, 0.82, 0.821, 0.822, 0.823, 0.824, 0.825, 0.826, 0.827, 0.828, 0.829, 0.83, 0.831, 0.832, 0.833, 0.834, 0.835, 0.836, 0.837, 0.838, 0.839, 0.84, 0.841, 0.842, 0.843, 0.844, 0.845, 0.846, 0.847, 0.848, 0.849, 0.85, 0.851, 0.852, 0.853, 0.854, 0.855, 0.856, 0.857, 0.858, 0.859, 0.86, 0.861, 0.862, 0.863, 0.864, 0.865, 0.866, 0.867, 0.868, 0.869, 0.87, 0.871, 0.872, 0.873, 0.874, 0.875, 0.876, 0.877, 0.878, 0.879, 0.88, 0.881, 0.882, 0.883, 0.884, 0.885, 0.886, 0.887, 0.888, 0.889, 0.89, 0.891, 0.892, 0.893, 0.894, 0.895, 0.896, 0.897, 0.898, 0.899, 0.9, 0.901, 0.902, 0.903, 0.904, 0.905, 0.906, 0.907, 0.908, 0.909, 0.91, 0.911, 0.912, 0.913, 0.914, 0.915, 0.916, 0.917, 0.918, 0.919, 0.92, 0.921, 0.922, 0.923, 0.924, 0.925, 0.926, 0.927, 0.928, 0.929, 0.93, 0.931, 0.932, 0.933, 0.934, 0.935, 0.936, 0.937, 0.938, 0.939, 0.94, 0.941, 0.942, 0.943, 0.944, 0.945, 0.946, 0.947, 0.948, 0.949, 0.95, 0.951, 0.952, 0.953, 0.954, 0.955, 0.956, 0.957, 0.958, 0.959, 0.96, 0.961, 0.962, 0.963, 0.964, 0.965, 0.966, 0.967, 0.968, 0.969, 0.97, 0.971, 0.972, 0.973, 0.974, 0.975, 0.976, 0.977, 0.978, 0.979, 0.98, 0.981, 0.982, 0.983, 0.984, 0.985, 0.986, 0.987, 0.988, 0.989, 0.99, 0.991, 0.992, 0.993, 0.994, 0.995, 0.996, 0.997, 0.998, 0.999%, or 1% TC or any range therein. The formulation can contain about 0.001% to about 0.5% (v/v) TC. In some embodiments, the formulation can contain about 0.075% v/v TC. In some embodiments, the effective amount of TC is about 0.075% v/v.

In some embodiments, the formulation contains at least an amount of each of TC and carvacrol. In some embodiments, the formulation contains only an amount of each of TC and carvacrol. In some embodiments, the formulation contains only an amount of each of TC, carvacrol, and a suitable diluent or carrier. In some embodiments the ratio of TC to carvacrol can range from 1:1 to 1:50. In some embodiments, the ratio of TC to carvacrol can range from 1:1 to 50:1. In some embodiments, the ratio of TC to carvacrol can be 1:1. In some embodiments, the effective ratio of TC to carvacrol is 1:1.

In some embodiments, the formulation contains at least an amount of each of TC and OO. In some embodiments, the formulation contains only an amount of each of TC and OO. In some embodiments, the formulation contains only an amount of each of TC, OO, and a suitable diluent or carrier. In some embodiments the ratio of TC to OO can range from 1:1 to 1:50. In some embodiments, the ratio of TC to OO can range from 1:1 to 50:1. In some embodiments the ratio of TC to OO can range from 1:1 to 1:50. In some embodiments, the ratio of TC to OO can range from 1:1 to 50:1. In some embodiments, the ratio of TC to OO can be 1:1. In some embodiments, the effective ratio of TC to OO is 1:1.

In some embodiments, the formulation contains at least an amount of each of OO and carvacrol. In some embodiments, the formulation contains only an amount of each of OO and carvacrol. In some embodiments, the formulation contains only an amount of each of OO, carvacrol, and a suitable diluent or carrier. In some embodiments, the ratio of OO to carvacrol can range from 1:1 to 1:50. In some embodiments, the ratio of OO to carvacrol can range from 1:1 to 50:1. In some embodiments, the ratio of OO to carvacrol can be 1:1. In some embodiments, the effective ratio of OO to carvacrol is 1:1.

In some embodiments, the formulation contains at least an amount of each of carvacrol, OO, and TC. In some embodiments, the formulation contains only an amount of each of carvacrol, OO, and TC. In some embodiments, the formulation only contains an amount of each of carvacrol, OO, TC, and a suitable diluent or carrier. In some embodiments, the ratio of carvacrol to OO to TC can range from 1:1:1 to 1:1:50. In some embodiments, the ratio of carvacrol to OO to TC can range from 1:1:1 to 1:50:1. In some embodiments, the ratio of carvacrol to OO to TC can range from 1:1:1 to 50:1:1. In some embodiments, the ratio of carvacrol to OO to TC can range from 1:1:1 to 50:50:1. In some embodiments, the ratio of carvacrol to OO to TC can range from 1:1:1 to 1:50:50. In some embodiments, the effective ratio of carvacrol to OO to TC can be 1:1:1.

In some embodiments, the plant extract component of the formulation contains only an amount of cinnamon oil. In some embodiments, the plant extract component of the formulation contains only an amount of citral. In some embodiments, the plant extract component of the formulation contains only an amount of cavacrol. In some embodiments, the plant extract component of the formulation contains only an amount of oregano oil. In some embodiments, the plant extract component of the formulation contains only an amount of trans cinnamaldehyde. Suitable amounts of each are as previously described.

The amounts of each of the plant extract(s) that can be included in the formulation can range from about 0.001 micrograms to about 1000 grams. The amounts of each of the plant extract(s), including an effective amount, can range from about 0.001 micrograms to about 0.01 micrograms. The amounts of each of the plant extract(s) including an effective amount, can range from about 0.01 micrograms to about 0.1 micrograms. The amounts of each of the plant extract(s), including an effective amount, can range from about 0.1 micrograms to about 1.0 grams. The amounts of each of the plant extract(s), including an effective amount, can range from about 1.0 grams to about 10 grams. The amounts of each of the plant extract(s) including an effective amount, can range from about 10 grams to about 100 grams. The amounts of each of the plant extract(s), including an effective amount, can range from about 100 grams to about 1000 grams.

The amounts of each of the plant extract(s) that can be included in the formulation can range from about 0.001 mL to about 1000 L. The amounts of each of the plant extract(s), including an effective amount, can range from about 0.001 mL to about 0.01 mL. The amounts of each of the plant extract(s) including an effective amount, can range from about 0.01 mL to about 0.1 mL. The amounts of each of the plant extract(s), including an effective amount, can range from about 0.1 mL to about 1.0 L. The amounts of each of the plant extract(s), including an effective amount, can range from about 1.0 L to about 10 L. The amounts of each of the plant extract(s) including an effective amount, can range from about 10 L to about 100 L. The amounts of each of the plant extract(s), including an effective amount, can range from about 100 L to about 1000 L.

In some embodiments, the primary active agent plant extract component is about 1 to about 100 percent of the total formulation (v/v, w/v, or wt. %). In some embodiments, the primary active agent plant extract component is about 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent of the total formulation (v/v, w/v, or wt. %). In some embodiments, the plant extract component is about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent of the total formulation (v/v, w/v, or wt. %).In some embodiments, the plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent of the total formulation (v/v, w/v, or wt. %). In some embodiments, the plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent of the total formation (v/v, w/v, or wt. %). In some embodiments, the plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent of the total formulation (v/v, w/v, or wt. %). In some embodiments, the plant extract component is about 20, 20.5, 21, 21.5, 22, 22.5, 23, 23.5, 24, 24.5, 25, 25.5, 26, 26.5, 27, 27.5, 28, 28.5, 29, 29.5 to/or 30 percent of the total formulation (v/v, w/v, or wt. %).

In some embodiments, the amount or effective amount of the one or more of the primary active plant extract agent(s) described herein contained in the pharmaceutical formulation can range from about 1 pg/kg to about 10 mg/kg based upon the bodyweight of the subject in need thereof or average bodyweight of the specific subject population to which the formulation can be administered.

### Auxiliary Agents and Other Ingredients

In addition to the primary active agent plant extract component, in some embodiments the formulation can optionally contain one or more additional auxiliary (also referred to herein as secondary agents) agents and/or other ingredients (carriers, excipients, colorants, stabilizers and the like). The secondary agents can optionally provide additional therapeutic effects different from, synergistic with, or additive to the primary active agent(s).

In some embodiments, auxiliary active agent can be included in the formulation or can exist as a stand-alone compound or formulation that can be administered contemporaneously or sequentially with the formulations containing the plant extracts described above. In aspects where the auxiliary active agent is a stand-alone compound or formulation, the effective amount of the auxiliary active agent can vary depending on the auxiliary active agent used and can be as described above. The auxiliary active agent can be simultaneously or sequentially administered with the formulations containing one or more plant extracts described above.

The formulation can include a carrier, including but not limited to, a pharmaceutically acceptable carrier. Suitable pharmaceutically acceptable carriers include, but are not limited to water, salt solutions, alcohols, gum arabic, vegetable oils, benzyl alcohols, polyethylene glycols, gelatin, carbohydrates such as lactose, amylose or starch, magnesium stearate, talc, silicic acid, viscous paraffin, perfume oil, fatty acid esters, hydroxy methylcellulose, and polyvinyl pyrrolidone, which do not deleteriously react with the active composition.

The pharmaceutical formulations can be sterilized, and if desired, mixed with agents, such as lubricants, preservatives, stabilizers, wetting agents, emulsifiers, salts for influencing osmotic pressure, buffers, coloring, flavoring and/or aromatic substances, and the like which do not deleteriously react with the active compound.

In some embodiments, the pharmaceutical formulation can also include an effective amount of secondary active agents, including but not limited to, biologic agents or molecules including, but not limited to, e.g. polynucleotides, amino acids, peptides, polypeptides, antibodies, aptamers, ribozymes, hormones, immunomodulators, antipyretics, anxiolytics, antipsychotics, analgesics, antispasmodics, anti-inflammatories, anti-histamines, anti-infectives, chemotherapeutics, and combinations thereof.

In some embodiments, the effective amount of each secondary active agent can each independently range from about 0 to 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 pg, ng, g, mg, or g or be any numerical value with any of these ranges.

In some embodiments, the effective amount can be an effective concentration. In some embodiments, the effective concentration of each secondary active agent can each independently range from about 0 to 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 pM, nM, M, mM, or M or be any numerical value with any of these ranges.

In some embodiments, the effective amount of each secondary active agent can each independently range from about 0 to 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 IU or be any numerical value with any of these ranges.

In some embodiments, each secondary active agent can be included in the formulation at a percentage of the total formulation ranging from about 0 to 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.9, to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, 99.9% w/w, v/v, or w/v of the formulation.

In some embodiments, the amount or effective amount of the one or more of the secondary agent(s) described herein contained in the pharmaceutical formulation can range from about 1 pg/kg to about 10 mg/kg based upon the bodyweight of the subject in need thereof or average bodyweight of the specific patient population to which the pharmaceutical formulation can be administered.

### Dosage Forms

The formulation that contains a primary active agent plant extract component as previously described can be provided in a dosage form. The dosage form can be administered to a subject in need thereof or a population thereof. The dosage form can be effective generate specific concentration, such as an effective concentration, at a given site in the subject in need thereof or in the environment (such as water) of the subject in need thereof. As used herein, “dose,” “unit dose,” or “dosage” can refer to physically discrete units suitable for use in a subject, each unit containing a predetermined quantity of the primary active agent, and optionally present secondary active ingredient, and/or a formulation thereof calculated to produce the desired response or responses in association with its administration.

In some embodiments, the plant extract component is about 10 to about 100 percent of the total dosage form (v/v, w/v, or wt. %). In some embodiments, the primary active agent plant extract component is about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, 99.5 to/or 100 percent of the total dosage form (v/v, w/v, or wt. %). In some embodiments, the primary active agent plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5 to/or 60 percent of the total dosage form (v/v, w/v, or wt. %). In some embodiments, the primary active agent plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5 to/or 50 percent of the total dosage form (v/v, w/v, or wt. %). In some embodiments, the primary active agent plant extract component is about 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5 to/or 40 percent of the total dosage form (v/v, w/v, or wt. %). In some embodiments, the primary active agent plant extract component is about 20, 20.5, 21, 21.5, 22, 22.5, 23, 23.5, 24, 24.5, 25, 25.5, 26, 26.5, 27, 27.5, 28, 28.5, 29, 29.5 to/or 30 percent of the total dosage form (v/v, w/v, or wt. %).

In some embodiments, the formulation can be a liquid. In some embodiments, the formulation can be a solid. In some embodiments, the formulation can be a substantially dry solid. In some embodiments, the formulation can be formulated as a concentrate that can be diluted for amounts ranges described above. The concentrate can be added to a liquid or a solid. In some embodiments, the solid is a substantially dry solid. In some embodiments, the formulation can be formulated as a feed additive. In some embodiments, the formulation is a feed. In some embodiments, the formulation can be formulated as a water additive. In some embodiments, the formulation can be added to a water source (like drinking water) or a water habitat (e.g. lake, pond, ocean, artificial pool, artificial pond, tank, and the like).

As previously described the formulations can contain a suitable diluent or carrier. Such diluents or carriers can include, but are not limited to, salt solutions, alcohols, gum arabic, vegetable oils, benzyl alcohols, polyethylene glycols, gelatin, carbohydrates such as lactose, amylose or starch, magnesium stearate, talc, silicic acid, viscous paraffin, perfume oil, fatty acid esters, hydroxy methylcellulose, and polyvinyl pyrrolidone, which do not deleteriously react with the active agent(s). In some embodiments, the carrier and/or diluent is an oil, such as a fish oil, or similar oil. In some embodiments, the carrier and/or diluent is DMSO.

The formulations can be sterilized, and optionally, mixed with auxiliary agents, such as lubricants, preservatives, stabilizers, wetting agents, emulsifiers, salts for influencing osmotic pressure, buffers, coloring, flavoring and/or aromatic substances, and the like which do not deleteriously react with the active compound(s).

The formulations can be provided in various dosage forms that can be administered to a subject or into its environment. Dosage forms of the formulations described herein can be discrete dosage units such as capsules, pellets or tablets, powders or granules, solutions, or suspensions in aqueous or non-aqueous liquids; edible foams or whips, or in oil-in-water liquid emulsions, water-in-oil liquid emulsions, oil-in-water liquid microemulsions, or water-in-oil liquid microemulsions. In some embodiments, the dosage form can also include one or more agents which flavor, preserve, color, or help disperse the formulation. Dosage forms can also be in the form of a liquid solution that can be delivered as a foam, spray, or liquid solution.

Where appropriate, the dosage forms described herein can be microencapsulated. The dosage form can also be prepared to prolong or sustain the release of any ingredient. In some embodiments, one or more of the primary active agent plant extracts is/are the ingredient(s) whose release is delayed. Suitable methods for delaying the release of an ingredient include, but are not limited to, coating or embedding the ingredients in material in polymers, wax, gels, and the like. Delayed release dosage formulations can be prepared as described in standard references such as “Pharmaceutical dosage form tablets,” eds. Liberman et. al. (New York, Marcel Dekker, Inc., 1989), “Remington—The science and practice of pharmacy”, 20th ed., Lippincott Williams & Wilkins, Baltimore, Md., 2000, and “Pharmaceutical dosage forms and drug delivery systems”, 6th Edition, Ansel et al., (Media, P A: Williams and Wilkins, 1995). These references provide information on excipients, materials, equipment, and processes for preparing tablets and capsules and delayed release dosage forms of tablets and pellets, capsules, and granules. The delayed release can be anywhere from about an hour to about 3 months or more.

Examples of suitable coating materials include, but are not limited to, cellulose polymers such as cellulose acetate phthalate, hydroxypropyl cellulose, hydroxypropyl methylcellulose, hydroxypropyl methylcellulose phthalate, and hydroxypropyl methylcellulose acetate succinate; polyvinyl acetate phthalate, acrylic acid polymers and copolymers, and methacrylic resins that are commercially available under the trade name EUDRAGIT® (Roth Pharma, Westerstadt, Germany), zein, shellac, and polysaccharides.

Coatings may be formed with a different ratio of water-soluble polymer, water insoluble polymers, and/or pH dependent polymers, with or without water insoluble/water soluble non polymeric excipient, to produce the desired release profile. The coating is either performed on the dosage form (matrix or simple) which includes, but is not limited to, tablets (compressed with or without coated beads), capsules (with or without coated beads), beads, particle compositions, “ingredient as is” formulated as, but not limited to, suspension form or as a sprinkle dosage form.

For some aspects, the dosage form contains a predetermined amount of a formulation described herein per unit dose. The predetermined amount of the formulation described herein can be an appropriate fraction of the total amount to be administered in a total dose (which can be based on e.g. a time frame (e.g.) minute, hour, day, month, year) or a total amount to treat a disease condition or disorder). Such unit doses may therefore be administered once or more than once a day (e.g. 1, 2, 3, 4, 5, 6, or more times per day). Such unit doses may therefore be administered once or more than once a week (e.g. 1, 2, 3, 4, 5, 6, or more times per week). Such unit doses may therefore be administered once or more than once a week (e.g. 1, 2, 3, 4, 5, 6, or more times per month). Such unit doses may therefore be administered once or more than once a year (e.g. 1, 2, 3, 4, 5, 6, or more times per year). Such formulations may be prepared by any of the methods well known in the art.

In some embodiments, no dosage is given a certain time prior to harvesting the organism for human consumption. This is referred to in the art as “withdrawal time”. In some embodiments, the withdrawal time can range from 0 to 30 days.

Effective dosages and schedules for administering the formulations provided herein may be determined empirically, and making such determinations is within the skill in the art. The dosage ranges for the administration of the compositions are those large enough to produce the desired effect in which the symptoms or disorder are affected. The dosage should not be so large as to cause adverse side effects, such as unwanted cross-reactions, anaphylactic reactions, and the like. Dosage can vary, and can be administered in one or more dose administrations daily, for one or several days. The range of dosage largely depends on the application of the compositions herein, severity of condition, and its route of administration.

Where appropriate, the dosage forms described herein can be a liposome. In these embodiments, primary active ingredient(s), and/or optional secondary active ingredient(s), and/or pharmaceutically acceptable salt thereof where appropriate are incorporated into a liposome. In embodiments where the dosage form is a liposome, the pharmaceutical formulation is thus a liposomal formulation. The liposomal formulation can be administered to a subject in need thereof.

Dosage forms adapted for topical administration can be formulated as ointments, creams, suspensions, lotions, powders, solutions, pastes, gels, sprays, aerosols, or oils. In some embodiments for treatments of the eye or other external tissues, for example the mouth or the skin, the pharmaceutical formulations are applied as a topical ointment or cream. When formulated in an ointment, a primary active ingredient, optional secondary active ingredient, and/or pharmaceutically acceptable salt thereof where appropriate can be formulated with a paraffinic or water-miscible ointment base. In other embodiments, the primary and/or secondary active ingredient can be formulated in a cream with an oil-in-water cream base or a water-in-oil base.

The dosage forms can be adapted for administration by any appropriate route. Appropriate routes include, but are not limited to, oral (including buccal or sublingual), rectal, intraocular, inhaled, intranasal, topical (including buccal, sublingual, or transdermal), vaginal, parenteral, subcutaneous, intramuscular, intravenous, internasal, and intradermal. Other appropriate routes are described elsewhere herein. Such formulations can be prepared by any method known in the art.

In some embodiments, the dosage form is adapted for administration through a feed or water source for the subject. In some embodiments, the dosage form is an animal feed, such as a suitable feed for crustaceans. In some embodiments, the dosage form is a feed for shrimp. The feed can include feed forms, which can be pellets, granules, flakes, powder, tablets, paste, or any other suitable feed form. In some embodiments, the feed form is coated with the primary and or optional secondary active ingredient(s). In some embodiments, the primary and or optional secondary active ingredient(s) are dispersed or mixed within the feed forms. Dispersion can be homogenous or heterogenous. The feed can be distributed to the subject for oral consumption to deliver the active agent(s) present in the feed.

In some embodiments, the dosage form is adapted for administration via the water environment of the subject. In some embodiments, such a dosage form can include the primary active agent(s) and optional secondary active agent at a concentration or amount such that when administered to the water it is diluted to a concentration or amount that can be effective to treat or prevent a Vibrio spp. infection or disease when ingested or absorbed by subjects within the water. In some embodiments, such dosage forms are solids, powders, gels, foams, or liquids.

### Kits

The formulations described herein and/or pharmaceutical formulations thereof described herein can be presented as a combination kit. As used herein, the terms “combination kit” or “kit of parts” refers to the compounds, or pharmaceutical formulations and additional components that are used to package, sell, market, deliver, and/or administer the combination of elements or a single element, such as the active ingredient, contained therein. Such additional components include but are not limited to, packaging, syringes, blister packages, bottles, and the like. When one or more of the components (e.g. active agents) contained in the kit are administered simultaneously, the combination kit can contain the active agents in a single pharmaceutical formulation (e.g. a tablet) or in separate pharmaceutical formulations.

When the agents are not administered simultaneously, the combination kit can contain each agent in separate pharmaceutical formulations. The separate pharmaceutical formulations can be contained in a single package or in separate packages within the kit.

The combination kit can also include instructions printed on or otherwise contained in a tangible medium of expression. The instructions can provide information regarding the content of the compound or pharmaceutical formulations contained therein, safety information regarding the content of the compound(s) or pharmaceutical formulation(s) contained therein, information regarding the dosages, indications for use, and/or recommended treatment regimen(s) for the compound(s) and/or pharmaceutical formulations contained therein. The instructions can provide directions for administering the compounds, compositions, pharmaceutical formulations, or salts thereof to a subject having, suspected of having, or predisposed to a disease, disorder, or condition described elsewhere herein. The instructions can provide directions for administering the compounds, compositions, pharmaceutical formulations, or salts thereof to a subject having, suspected of having, or predisposed to developing Vibrio spp. infection or a symptom thereof formulations and/or co-treatments described herein that can be included in the kit.

### Methods of Treating Vibrio Spp. Infection

The formulations described herein can be administered to a subject in need thereof via any appropriate route. In some embodiments, the method can include administering an amount of a formulation as described elsewhere herein to a subject. The method can include contacting a Vibrio spp. with an amount of a formulation described herein. The method can include administering the formulation to the environment of the subject such that the subject can ingest or absorb the formulation or a component thereof. The subject in need thereof can be a non-human animal. In some embodiments, the subject can be a crustacean. In some embodiments, subject is a shrimp. In some embodiments, the formulation can be delivered to the subject through its feed and/or water. In some embodiments, such as for use in aquaculture, the formulation can be delivered through the water that is the subject's habitat or environment. Such water sources include natural ponds, lakes, oceans, rivers streams, and the like. Such water sources can include artificial habitats such as tanks, pools, ponds, and the like.

As previously discussed, the formulation can be effective to treat or prevent an infection caused by a Vibrio spp in a subject to which it is delivered. In some embodiments, the formulation can be effective to reduce, inhibit, and/or eliminate pathogenicity of a Vibrio spp., such as in a subject or environment to which it is delivered. In some embodiments, the formulation can be effective to reduce, inhibit, and/or eliminate growth and/or development of a Vibrio spp., such as in a subject or environment to which it is delivered. In some embodiments, the formulation can be effective to kill a Vibrio spp., such as in a subject or environment to which it is delivered. In some embodiments, the subject has or is suspected of being infected with an organism of a Vibrio spp. In some embodiments, the subject is exposed to an organism of a Vibrio spp.

Also described herein are methods of treating or preventing a Vibrio spp, infection in a subject comprising: administering amount of a formulation as described herein to a subject. The subject can be a non-human animal. The subject can be a crustacean. The crustacean is a shrimp.

In some embodiments, the method can include reducing, inhibiting, and/or eliminating pathogenicity of a Vibrio spp., such as in a subject or environment to which a formulation described herein is delivered. In some embodiments, the method can include reducing, inhibiting, and/or eliminating growth and/or development of a Vibrio spp., such as in a subject or environment to which a formulation described herein is delivered. In some embodiments, the method can include killing a Vibrio spp., such as in a subject or environment to which a formulation described herein is delivered.

In some embodiments, the formulas can be used to decontaminate tanks, pond, raceways, etc. before a subject, such as a non-human animal, is placed in them and/or after the subject(s) are removed. In some embodiments, the presence of an infection, such as a Vibrio spp. infection, and/or AHPND can be determined using any of the methods, compositions, and/or formulations in U.S. Provisional Application No. 62/808,701, filed Feb. 21, 2019, entitled “PCR Assays For Specific Detection Of Enterocytozoon Hepatopenaei” and U.S. application Ser. No. 16/798,283, filed Feb. 21, 2020, entitled “PCR Assays For Specific Detection Of Enterocytozoon Hepatopenaei”.

The formulations or dosage forms thereof described herein can be administered one or more times hourly, daily, monthly, or yearly (e.g. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 or more times hourly, daily, monthly, or yearly). In some embodiments, the formulations or dosage forms thereof described herein can be administered continuously over a period of time ranging from minutes to hours to days. Devices and dosages forms are known in the art and described herein that are effective to provide continuous administration of the formulations described herein. In some embodiments, the first one or a few initial amount(s) administered can be a higher dose than subsequent doses. This is typically referred to in the art as a loading dose or doses and a maintenance dose, respectively. In some embodiments, the formulations can be administered such that the doses over time are tapered (increased or decreased) overtime so as to wean a subject gradually off of a formulation or gradually introduce a subject to the formulation.

Further embodiments are illustrated in the following Examples which are given for illustrative purposes only and are not intended to limit the scope of the invention.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure. The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

### Example 1—Evaluation of the Efficacy of Plant-Derived Extracts to Control AHPND

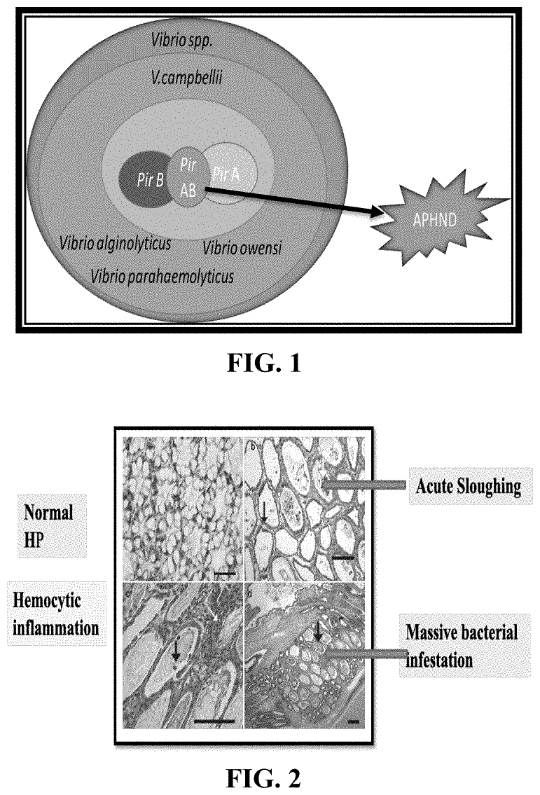

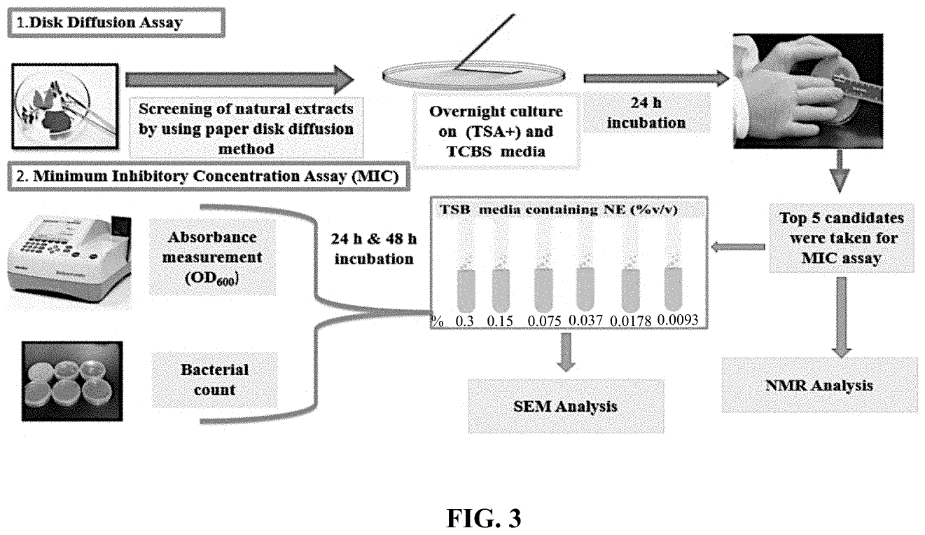

Acute Hepatopancreatic Necrosis Disease (AHPND), caused by Vibrio parahaemolyticus expressing plasmid-borne binary toxins, PirA, and PirB, to the sustainability of shrimp farming globally. FIG. 1 shows a schematic of virulence factor of AHPND Toxin genes (pirA & pirB) in the plasmid. The target organ in shrimp for this disease is the hepatopancreas. FIG. 2 shows the histopathology of HP from APHND infected P. vannamei shrimp. Adapted from Dhar et al., 2018. There is no therapeutic against AHPND and the use of antibiotics is not feasible due to potential residues in commodity shrimp and the development of drug-resistant bacteria. This Example evaluates the efficacy of plant-derived extracts to control AHPND.

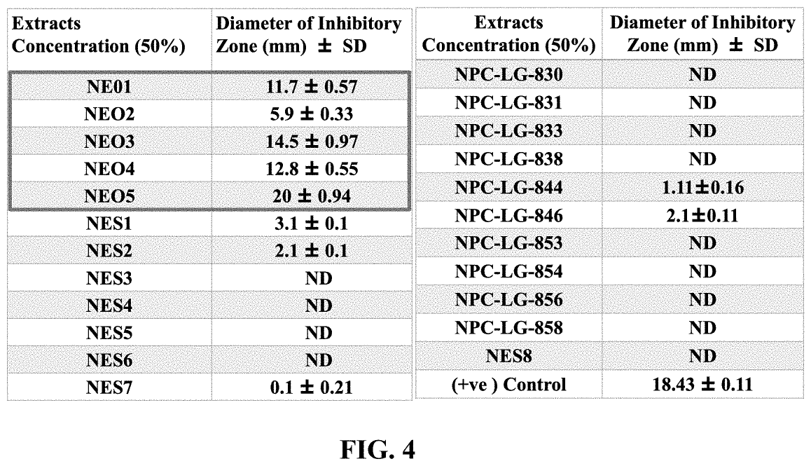

Eighteen extracts (NE01-NE018) were initially screened against V. parahaemolyticus using paper disk diffusion assay and top five extracts that exhibited high antimicrobial activity were taken for further screening using minimum inhibitory concentration (MIC) assay in liquid culture. Absorbance (OD₆₀₀) and total colony count (upon plating overnight culture grown in the presence of natural extracts) were employed for screening. FIG. 3 shows a diagram of the methodology of a disk diffusion assay and MIC assay used.

In disk diffusion assay, the inhibition zones of five compounds were significantly higher than the remaining 18 compounds (P<0.05). The MIC assay results (expressed as v/v %) showed that NE01, NE02, NE03, NE04, and NE05 were effective at 0.015%, 0.015%, 0.007%, 0.007%, and 0.002% concentrations, respectively. Considering there is no published record of using NE05 as an antimicrobial against any bacterial pathogens of shrimp, and it is most efficacious among the natural extracts screened, NE05 is a potential candidate to develop as AHPND therapeutic.

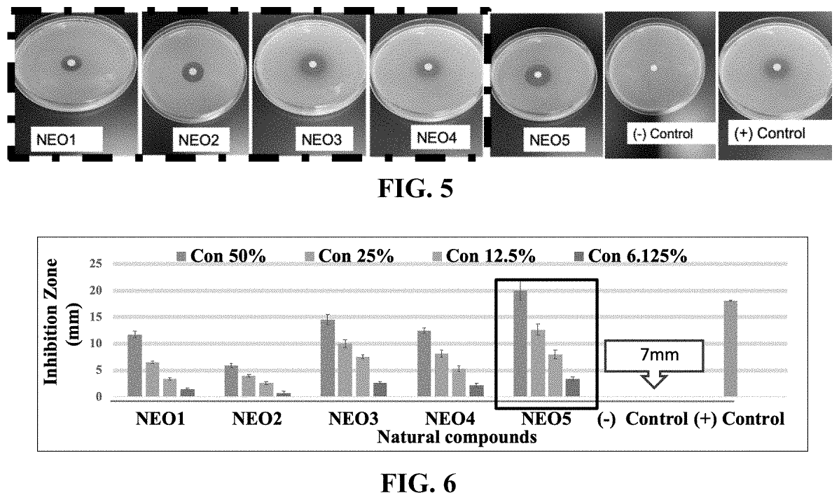

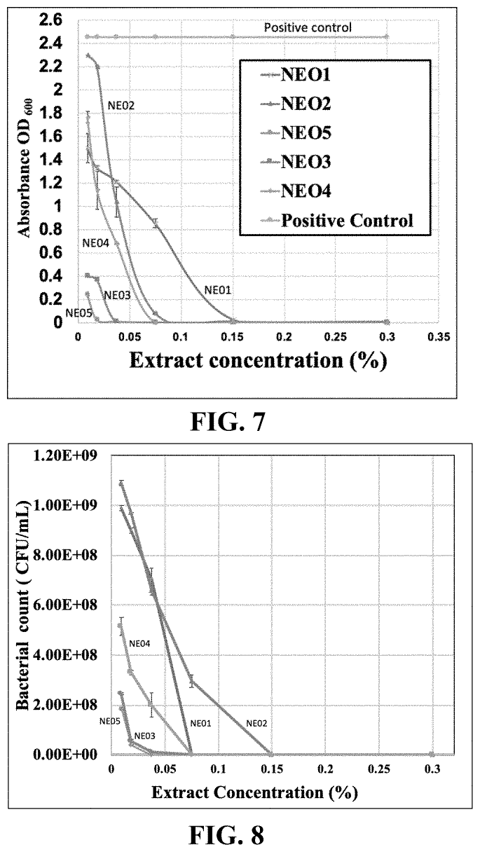

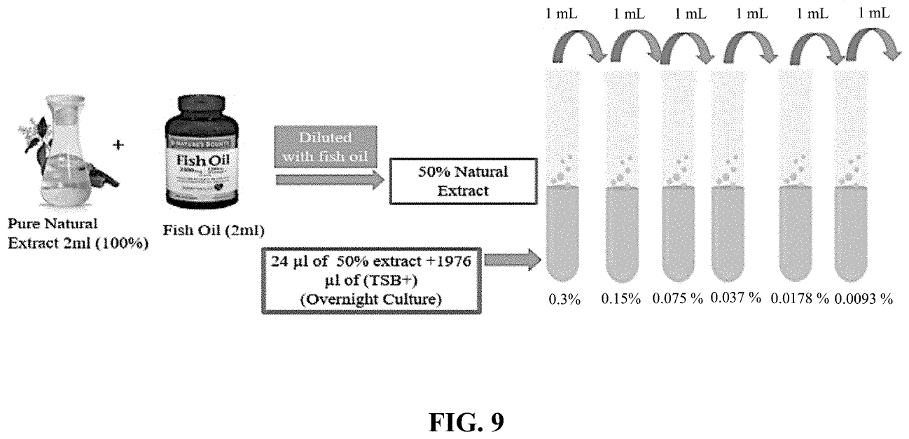

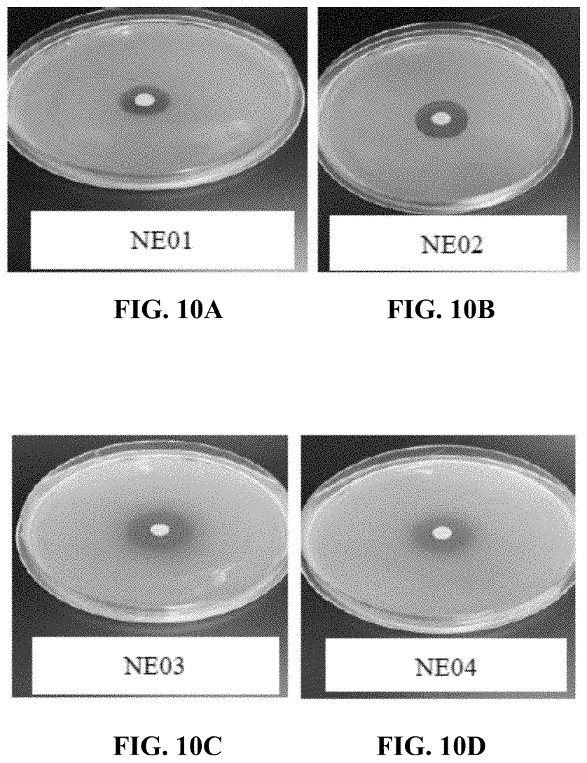

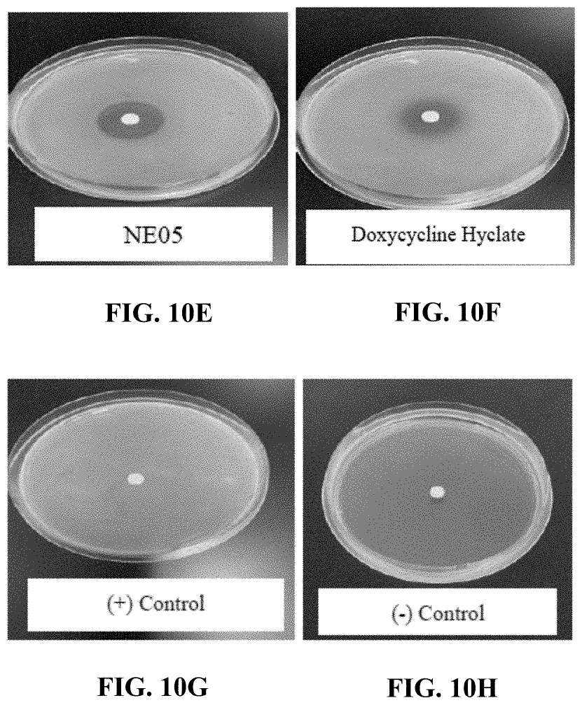

FIG. 4 shows tables that can demonstrate the efficacy of plant extracts (N=18) in inhibiting Vibrio parahaemolyticus growth as measured by diameter of inhibitor zone (in mm) using a disk diffusion assay. FIG. 5 shows images that can demonstrate results from the disc diffusion assay and show antimicrobial activity of the top 5 natural extracts on TSA+media. FIG. 6 shows a graph that can demonstrate Antimicrobial activity of top 5 candidate natural extracts tested at different concentrations. Fish oil used as (−ve) Control, and antibiotic Doxycycline hyclate (+ve) Control, >7 mm considered as antimicrobial activity. FIG. 7 shows a graph that can demonstrate V. parahaemolyticus growth (OD600) at 48 h. FIG. 8 shows a graph that can demonstrate V. parahaemolyticus colony count at 48 h.

### Example 2—Screening of Natural Extracts for Efficacy Against Vibrio Spp.

### Methods

The antimicrobial activities of natural extracts (NEs) against AHPND-causing V. parahaemolyticus were tested in vitro by using a paper disk diffusion assay. The minimum inhibitory concentration (MIC) of top five candidate NEs was identified following a previously published method with minor modifications (Mith et al., 2014). The effect of NEs on V. parahaemolyticus was determined by examining the bacterial cells under a Scanning Electron Microscope (SEM). Finally, the efficacy of the best candidate NE, NE05 was evaluated in vivo by oral administration of NE05 through diet to Specific Pathogen Free (SPF) shrimp (P. vannamei) followed by an immersion challenge of V. parahaemolyticus. The details for each of these experiments are described below.

### VP_{AHPND} Strain

VP_{AHPND} (13-028/A3) was revived from glycerol stock kept in −80 degrees C. in Aquaculture Pathology Laboratory following a previous publication (Han et al., 2015). Briefly, 800 mL of Tryptic Soy Broth (TSB) containing 2% NaCl (TSB+) medium was prepared and autoclaved. The bacterial stock was thawed on ice and briefly vortexed before transferring 250 μl of the bacterial culture to 5 ml TSB+ in a 50 ml flask. The flask was incubated at 28 degrees C. in a shaker incubator (CORNING, Model LSE) (120 rpm) for 2 h. After the incubation, the broth was transferred into 50 ml TSB+ in a 250 ml flask before incubating at 28 degrees C. in a shaker incubator (120 rpm) for 2 h. After 2 h., the bacterial culture was mixed with 300 ml TSB and incubated for 24 h at 28 degrees C. After 24 h, the optical density (OD) of the culture was measured at 600 nm. Under these culture conditions, the OD values should exceed 2.8. The broth was diluted to 1×10⁷ CFU/ml based on the OD reading. A 10-fold serial dilution of the bacterial culture was prepared and the live bacterial count upon overnight growth was determined by plating the culture on Tryptic Soy Agar (TSA) containing 2% NaCl (TSA+) plates.

### Natural Extracts

A total of 18 NEs were screened against VP_{AHPND} (13-028/A3). Thirteen of these 18 NEs (Numbered NE01 to NE18). These extracts were stored at 4° C. until use.

### Disc Diffusion Assay

The antibacterial activities of the NEs were tested using a paper disk diffusion assay following a previously published method with some modifications (Mith et al., 2014). Briefly, the extracts were diluted with fish oil (NE01-NE013) or DMSO (NE14 to NE18) at the following concentrations: 1:1, 1:2, 1:4, and 1:8. The VP_{AHPND} (13-028/A3) culture lawns were created on TSA+plates by thoroughly streaking the culture over the entire surface of the plate with a cotton swab. Meanwhile, 2 μL of each concentration of the NEs was soaked on to a paper disk for 15 min before placing in the center of the bacteria inoculated TSA+plates. Fish oil and DMSO were used as controls. For each dilution of the NE two replicates were done. The plates were then incubated at 28° C. for 24 hr. The efficacy of the extract in inhibiting bacterial growth was determined by measuring the diameter of clear zones for each concentration to the nearest millimeter (mm). The diameter of the inhibitory zone <7 mm was considered as having no antimicrobial activity (Mith et al., 2014). The experiments were repeated four times for all 18 NEs, and the average was taken to calculate the diameter of the inhibitory zone. A schematic representation of the disk diffusion assay is presented in FIG. 3.

### Determination of Minimum Inhibitory Concentration (MIC) of Natural Extracts.

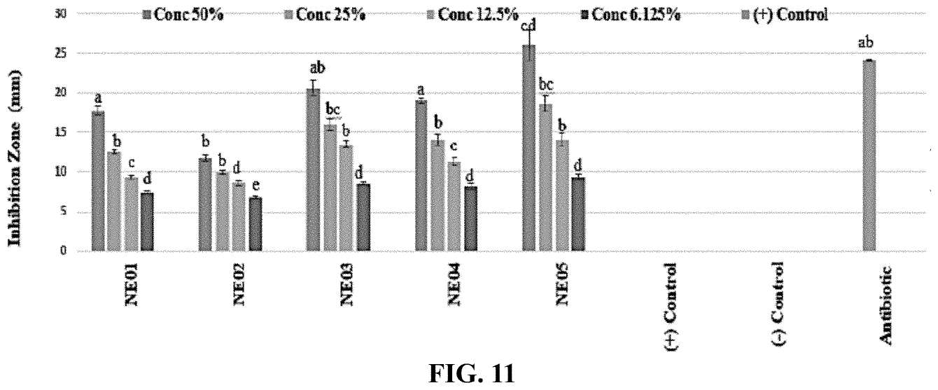

Five extracts that exhibited the highest antimicrobial activity in the paper disk diffusion assay, NE01, NE02, NE03, NE04 and NE05 were selected to assess the minimum inhibitory concentration (MIC). Initially extracts were diluted up to 50% with diluent fish oil, then a serial dilution of extracts was prepared Concentrations of extracts range between [0.3-0.0937% (v/v)], which was prepared in TSB+ (Tryptic soy broth) medium. The culture medium TSB+ (2 ml) containing NEs was inoculated with 100 μL (approx. 1×107 CFU/mL) of an overnight culture of the pathogen and briefly mixed by vortexing before incubating at 28 degrees C. The OD600 values was recorded at 12, 24 and 48 h post-incubation (FIG. 9). In addition, at each time point and for each concentration of the NEs, aliquots of bacterial suspension were inoculated on TSA+plate before incubating overnight at 28 degrees C. The MIC for each NE was determined by recording OD600 values and taking bacterial count. For each NE, the MIC assay was repeated three times on different days, and the average OD600 value was taken to determine the MIC for each concentration of a corresponding NE. A schematic representation of the MIC assay is shown in FIG. 9.

### Scanning ElectronMicroscopy (SEM) of NE Treated VP_{AHPND} Cells

The effect of NEs on bacterial cells was determined by culturing VP_{AHPND} in medium containing NEs and examining the cells under a scanning electron microscope (SEM). The subinhibitory concentration of extracts used in the medium was MIC. The control treatment was VP_{AHPND} grown in the presence of fish oil. Samples were fixed by following a protocol described by Lv et al. (2011) and McQuade et al. (2012) with some modifications. Briefly, 25 μl of 8% glutaraldehyde solution (Electron Microscopy Sciences, Hatfield, Pa.) was added to 200 μl of the overnight culture of bacteria. After 40 minutes of incubation at room temperature, samples were washed three times with 1× phosphate-buffered saline (PBS, pH 7.0). Subsequently, samples were washed with water and stained with 1% osmium tetroxide (Ted Pella, Inc., Redding, Ariz.). Finally, samples were washed in water and dehydrated in a series of ethanol solutions with concentrations ranging from 30% to 90% (v/v). The slides with fixed bacterial cells were mounted, sputter-coated in gold under vacuum, and examined using a Hummer S-4800 field emission scanning electron microscope (ANATECH, USA).

### AHPND Bioassay

### Preparation of Shrimp Diet Containing Natural Extract

The efficacy of NE05 in preventing AHPND was evaluated by using an in vivo assay. The NE05 was mixed with a commercially pelleted shrimp diet at concentrations of 20% and 10% (v/w). Commercial diets containing 20% and 10% fish oil were used as controls. The feed was prepared using a standard feed maker (CORNING, Model LSE) and dried in a chemical hood for 24 h at room temperature. The feed was coated with fish oil dried for an additional 12 h to prevent the smell and increase palatability.

### Tank Preparation for the Bacterial Challenge Study

Ten 37 L glass tanks were used in this study. Seawater was prepared following a SOP used in Aquaculture Pathology Laboratory. Approximately 800 g of sea salt (Marinex, Baltimore, Md.) was mixed with 30 L of tap water to get 20-25 ppt of salinity. After the marine salt was dissolved, salinity was checked using a refractometer (SPER SCIENTIFIC, Model #300011). The salinity level of the water was adjusted by adding water until the range needed for the study was reached (20-25 ppt). Throughout the experiment, the room temperature was maintained at 29±2 degrees C. using a heater. Before starting the bioassay, the tanks were held for two days without any animal to equilibrate the water temperature to that of the room. The water temperature was maintained at 29±2 degrees C. Each tank was equipped with an air pump having an air capacity of 2.5 liters/min connected to two air stones. One air stone was directly immersed into the tank, and the other one was connected to the filters. Disinfected weight was kept above each air stone. The heater was kept inside the room during the experiment.

Immersion Challenge of Specific Pathogen Free Shrimp (Penaeus Vannamei) with AHPND-Causing Vibrio parahaemolyticus

Specific Pathogen Free shrimp (P. vannamei) (avg. weight 1-2 g) were stocked at a density of 10 shrimp/tank. In total there were two treatments and two controls: shrimp fed diet containing 20% NE05, 10% NE05, a positive and a negative control (shrimp fed diet containing fish oil). Each treatment and control had two replicates. Animals in all treatments except the negative control were subjected to an immersion challenge with V. parahaemolyticus. In the negative control tanks, sterilized TSB+ medium was added instead of bacterial suspension. Throughout the experiment, shrimps were fed corresponding diets daily at 5% of their body weight. The experiments were repeated three times. On day 6 post-feeding of the experimental diets, shrimps were challenged with V. parahaemolyticus at a dose of 106 CFU/ml (500 ml of V. parahaemolyticus culture grown for 24 h, OD600 of 5). After the bacterial challenge, tanks were monitored several times a day, and mortalities were recorded, and dead shrimps were removed immediately. Hepatopancreas tissue from moribund shrimp was dissected, half of the tissue was preserved in Davidson's fixative for histopathology, while the remaining half of hepatopancreas was stored at −20 degrees C. for PCR detection of V. parahaemolyticus. In dead animals, hepatopancreas tissue gets autolyzed and hence not taken for histopathology, instead stored at −20 degrees C. for the PCR detection of V. parahaemolyticus. At the termination of the bioassay, average mortality for each treatment was calculated, and one-way ANOVA was performed to determine any significant difference among different treatments. A (p-value <0.05) between treatments was considered significant. Table 1 shows the experimental design for evaluating the efficacy of natural extract, NE05 in controlling AHPND in an experimental challenge using Penaeus vannamei shrimp.

TABLE 1

| | | Average | Density | Bacterial | | |
|---|---|---|---|---|---|---|
| | | body weight | Animal/ | Density | Challenge | |
| Group | Replicates | (g) | Tank | CFU/mL | Method | Feed |
| Positive | 2 | 1-2 | 10 | 10⁶ | AHPND | Regular feed |
| Control | | | | | | coated with |
| | | | | | | fish oil |
| Negative | 2 | 1-2 | 10 | 10⁶ | Sterile | Regular feed |
| Control | | | | | TSB | coated with |
| | | | | | | fish oil |
| Treatment 1 | 2 | 1-2 | 10 | 10⁶ | AHPND | Feed treated |
| | | | | | | with NE05 at |
| | | | | | | 10% and |
| | | | | | | coated with |
| | | | | | | Fish oil |
| Treatment 2 | 2 | 1-2 | 10 | 10⁶ | AHPND | Feed treated |
| | | | | | | with NE05 at |
| | | | | | | 20% and |
| | | | | | | coated with |
| | | | | | | Fish oil |

Detection of pirA and pirB Genes in AHPND-Causing Vibrio parahaemolyticus Using DNA Extraction and Conventional PCR

Total genomic DNA was isolated from hepatopancreas using a DNA easy blood and tissue kit (Qiagen, Valencia, Calif., USA) following manufacture's protocol. The pirA and pirB genes were detected by a duplex PCR using PuReTaq ready-to-go PCR beads and following a published protocol (Han et al., 2015). The primers used for the amplification of a 284 bp amplicon of pirA gene were VpPirA-284F: VpPirA-284F TGACTATTCTCACGATTGGACTG (SEQ ID NO: 1)/R VpPirA-284R TGACTATTTCACGATTGGACTG (SEQ ID NO: 2), and the primers VpPirB-392F TGAAGTGATGGGTGCTC (SEQ ID NO: 3)/R VpPirB-392R TGT AAGCGCCGTTTAACTCA (SEQ ID NO: 4) were used to amplify a 392 bp region of the pirB gene. Amplifications were performed with the following parameters: an initial denaturation at 94° C. for 3 min, followed by 35 cycles of 94° C. for 30 s, 60° C. for 30 s, and 72° C. for 30 s; and a final extension at 72° C. for 7 min. Following PCR, the amplicons were analyzed in a 2% gel containing 1:1000 Gelred (Biotium, USA), and the gel was photographed using a BIORAD Gel Doc XR+ imaging system (Hercules, USA).

### Histopathology Analysis of Moribund Shrimp

Moribund shrimp were fixed in Davidson's alcohol-formalin-acetic acid (AFA). The samples were processed, embedded in paraffin, and sectioned (5 m thick) following a standard protocol (Lightner, 1996). The sections were stained with hematoxylin and eosin (H&E) and examined using a light microscope for histological lesions of AHPND (Tran et al., 2013).

### Results

### Antimicrobial Activities of Natural Extracts as Determined by the Disk Diffusion Assay

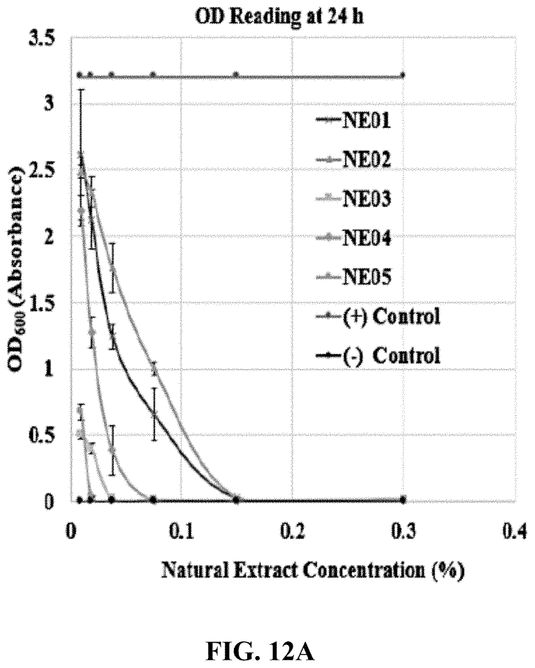

Antibacterial activities of 18 natural extracts against Vibrio parahaemolyticus causing AHPND (VP_{AHPND}) were assessed by a disk diffusion assay. The zones of inhibition measured for all 18 NEs varied between 0 to 26. Only those extracts that provided a zone of inhibition that is significantly higher than 7 mm (p<0.05) were selected for subsequent assay. Accordingly, Five out of 18 NEs, NE01, NE02, NE03, NE04 and NE05 were taken for minimum inhibitory concentration (MIC) assay. The inhibition zones produced by these five extracts against ranged from approximately 11.8 to 26 mm in diameter (Table 2, FIGS. 10A-10H). Table 2 shows the efficacy of plant extracts (N=18) in inhibiting AHPND-causing Vibrio parahaemolyticus growth as measured by the diameter of inhibition zone (in mm) formed after performing a disk diffusion assay. These five NEs consistently provided strong inhibition against V. parahaemolyticus in all four independent assays performed. The zones of inhibition measured for the remaining NEs were not significantly higher than 7 mm (varied between 0 to 8.1 mm, Table 2). These remaining NEs were not taken for further evaluation. No inhibition zone was observed in negative control. It was interesting to note that among the five most effective NEs, NE05 showed significantly higher inhibition compared to NE01, NE02, NE03 and NE04, (P<0.05), and even higher than the positive control antibiotic reference standard, Doxycycline Hyclate (26±1.8 vs. 24.43±0.57).

TABLE 2

| Natural | | Average diameter of inhibitory zone (mm) | | | |
|---|---|---|---|---|---|
| Extract ID | Natural Extract | CNE ½ | CNE ¼ | CNE ⅛ | CNE 1/16 |
| NE01 | Citral | 17.75 ± 1.4 | 12.53 ± 0.50 | 9.36 ± 0.58 | 7.48 ± 0.42 |
| NE02 | Cinnamon oil | 11.8 ± 0.90 | 10 ± 0.54 | 8.56 ± 0.62 | 6.76 ± 0.60 |
| NE03 | Cavacrol | 20.51 ± 0.97 | 16 ± 0.77 | 13.53 ± 0.42 | 8.53 ± 0.16 |
| NE04 | Oregano Oil | 18.98 ± 0.56 | 14.13 ± 0.68 | 11.35 ± 0.49 | 8.18 ± 0.31 |
| NE05 | Trans | 26 ± 1.8 | 18.66 ± 0.98 | 14.03 ± 0.80 | 9.36 ± 0.32 |
| | Cinnamaldehyde | | | | |
| NE06 | Apple | 9.1 ± 0.11 | 7.4 ± 0.16 | ND | ND |
| | skin extract | | | | |
| NE07 | Olive seed | 7.1 ± 0.11 | 6.9 ± 0.15 | ND | ND |
| | extract | | | | |
| NE08 | Unknown | ND | ND | ND | ND |
| NE09 | Unknown | ND | ND | ND | ND |
| NE10 | Unknown | ND | ND | ND | ND |
| NE11 | Unknown | ND | ND | ND | ND |
| NE12 | Polysaccharide | 6.2 ± 0.34 | ND | ND | ND |
| NE13 | Unknown | ND | ND | ND | ND |
| NE14 | Unknown | ND | ND | ND | ND |
| NE15 | Unknown | ND | ND | ND | ND |
| NE16 | Unknown | ND | ND | ND | ND |
| NE17 | Unknown | 7.1 ± 0.11 | 6.5 ± 0.14 | ND | ND |
| NE18 | Unknown | 8.1 ± 0.11 | 6.9 ± 0.15 | ND | ND |
| (+) Control | Paper disk | ND | ND | ND | ND |
| | soaked in fish | | | | |
| | oil | | | | |
| (−) Control | Tryptic Soy | ND | ND | ND | ND |
| | Agar | | | | |
| Antibiotic | Doxycycline | 24.43 ± 0.57 | ND | ND | ND |
| | Hyclate | | | | |

Diameter of inhibition zone <7 mm was considered as no antimicrobial activity.
ND: not detected, CNE: Concentrations of Natural Extracts (½, ¼, ⅛, 1/16; v/v) used.
Values are mean diameter of inhibitory zone (mm) ± SD of replicates, (+) Control = V. parahaemolyticus strain A3 with fish oil, (−) Control = Tryptic Soy Agar, Antibiotic = (Doxycycline Hyclate) (10 μg).

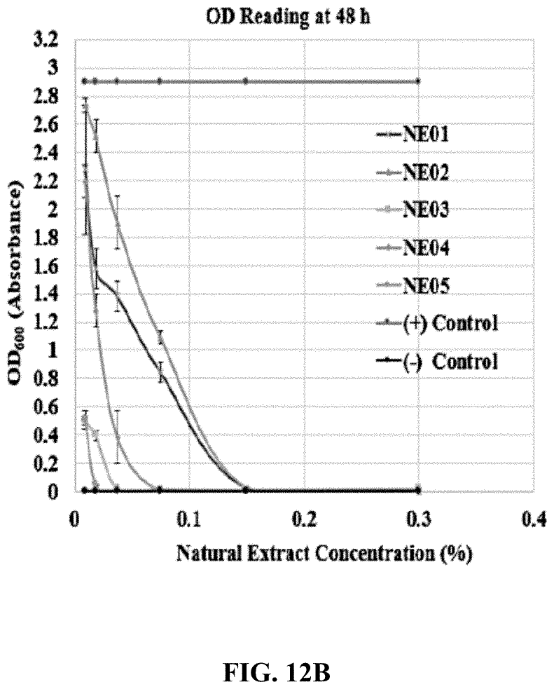

The concentration-dependent anti—V. parahaemolyticus activity at different concentrations of each of the five most effective candidate NEs is shown in FIG. 11. Overall there was a declining trend in inhibition as the concentration of the compounds decreased (FIG. 11). Thus, the inhibitory effect of each extract showed a positive correlation with concentration. An analysis of variance among different concentrations of the five NEs revealed that the antimicrobial activity varied significantly among the five NEs and among the different concentrations within each NEs (P<0.05). Among the five NEs, the inhibition zone produced by NE05 was significantly larger compared to the remaining four NEs for any specific concentration (P<0.05). The five most effective NEs were, therefore, selected for performing the minimum inhibition concentration (MIC) assay.

### Minimum Inhibitory Concentration (MIC) of Natural Extracts

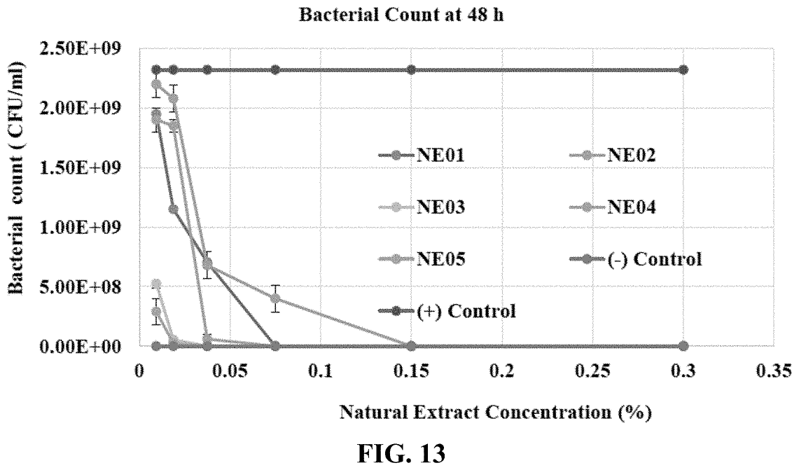

The MIC was determined by measuring the bacterial growth at OD600 and counting bacterial colonies after 24 h and 48 h of incubating V. parahaemolyticus in TSB (Tryptic soy broth) Containing different concentrations of NE01, NE02, NE03, NE04, and NE05. FIGS. 12A-12B shows the antibacterial effect of NE01, NE02, NE03, NE04 and NE05 at different concentrations at 24 h and 48 h post-incubation of V. parahaemolyticus. As evidenced by OD600 values, the positive control had an OD600 value of 3.25 at 24 hr. During the same time, the OD600 of NE01 was 2.5 at a concentration of 0.0983% and it reached zero at 0.15% (v/v). Like NE01, no survivors are detected in NE02 at 0.15% (v/v). No survivors are detected in NE03 and NE04 at 0.075% and 0.04% (v/v), respectively. Unlike the other four NEs, no survivors are detected in NE05 at 0.02% (v/v). Therefore, the MICs of NE01, NE02, NE03, NE04, and NE05 were 0.15%, 0.15%, 0.075%, 0.04%, and 0.02% (v/v %), respectively (FIGS. 12A-12B).

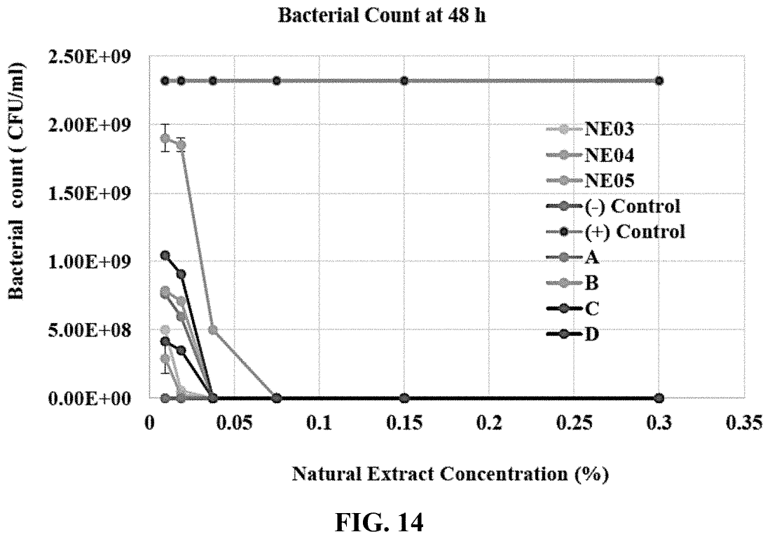

The viable bacterial counts at 48 h for all five NEs treatments are shown in FIG. 13. Total bacterial colony count in the positive control treatment reached 2.25×10¹ CFU/ml at 48 hr. and there was no growth in the negative control treatment. In contrast, in NE01 treatment bacterial count was 2.5×10⁹ CFU/ml at the lowest extract concentration (0.0983%) and it reached down to zero at 0.15% (v/v) concentration. The treatment with NE02 also had a bacterial count of 2×10⁹ CFU/ml at 0.0983% (v/v) concentration and the total count reduced to zero at extract concentration 0.15% (v/v). The treatments NE03 and NE04 exhibited no survivors at extract concentration of 0.075% and 0.04% (v/v %), respectively. No survivors are detected in extract NE05 at very low concentration, 0.02% (v/v). Therefore, among five NEs tested, NE05 had the lowest MIC value as determined by OD600 values in liquid culture and by bacterial colony count on TSA+plates (FIG. 13).

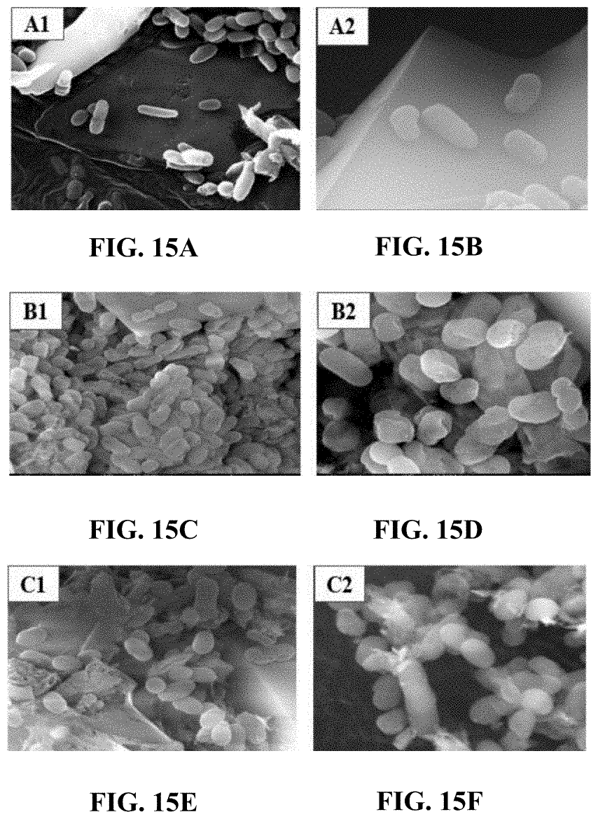

Based on the initial MIC data of five natural extracts, NE03, NE04, and NE05 were tested in different combinations to determine the efficacy of the extracts against V. parahaemolyticus. FIG. 14 shows all combinations of NEs, i.e. NE05+NE03 (1:1, Combination A), NE03+NE04 (1:1, Combination B), NE05+NE04 (1:1, Combination C), NE03+NE04+NE05 (1:1:1, Combination D) were effective in reducing bacterial growth in liquid culture assay and MIC was below 0.05% for all four combinations. All four-combinations showed significantly higher bactericidal effects compared to positive control (P<0.05), and there was no significant difference among the combinations A, B, and D. However, Combination D had a greater Antimicrobial effect than the remaining combinations.

### Scanning Electron Microscopy (SEM) of VPAHPND Cells Exposed to the NEs

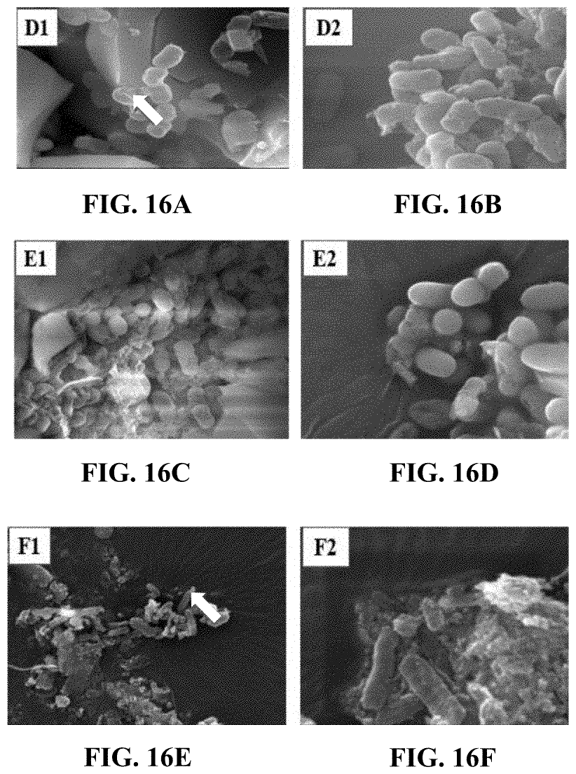

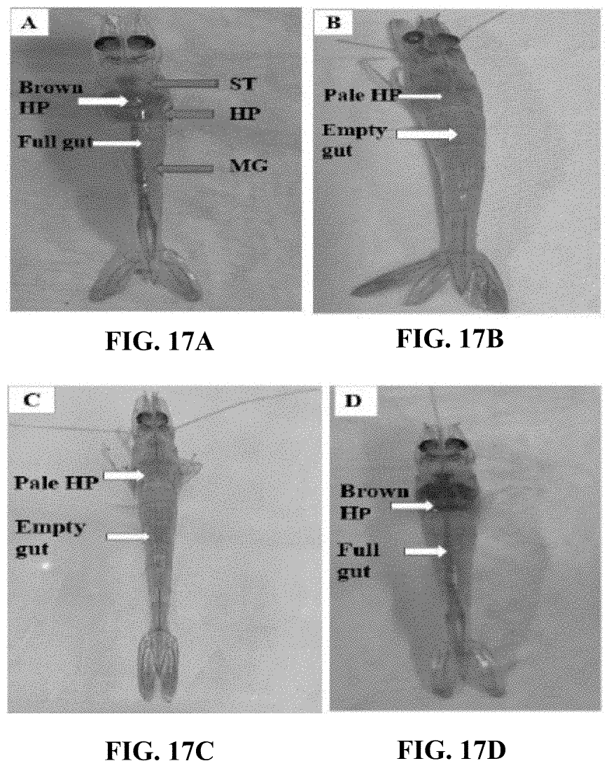

The effects of NEs on VPAHPND cells were determined by growing the bacteria in the presence of a sub-inhibitory concentration of each of the five most effective NEs and examining the bacterial cell morphology under a scanning electron microscope (SEM). Representative SEM images obtained for V. parahaemolyticus cells with or without any treatment of the five NEs at different magnifications are shown in FIGS. 15A-15F and 16A-16F. Untreated bacteria appeared to have regular morphology (i.e. curved rod-shaped) with a smooth and intact surface. The cell surface did not display any damage or pores (FIGS. 15A-15B).

SEM analysis of bacterial cells treated with NE01 showed a few irregular wrinkled cells but also had a lot of intact cells in any viewing field (FIGS. 15C-15D). Bacterial cells treated with NE02 did not exhibit any changes. The cells had a regular morphology and a high number of bacterial cells could be seen in a viewing field (FIGS. 15E-15F). SEM analysis of bacterial cells treated with NE03 showed non-intact lysed cells with possible leaking out of cytoplasmic constituents (FIGS. 16A-16B). SEM analysis of bacterial cells treated with NE04 revealed damaged bacterial cells releasing intracellular components and cell surface ruptures (FIGS. 16C-16D). Bacterial cells treated with the natural extract NE05, showed extensive cell wall damage, and possible leaking out of intracellular components caused due to cell lysis (FIGS. 16E-16F). The cell morphology was also substantially altered as the cells became elongated or completely deformed (FIG. 16E).

Overall, the SEM images revealed that the bacterial cells treated with NE03, NE04, and NE05 displayed disruption of cell surface and leaking of cytoplasmic components than NE01 and NE02.

### AHPND Bioassay: Clinical Sign, Mortality, PCR and Histopathology

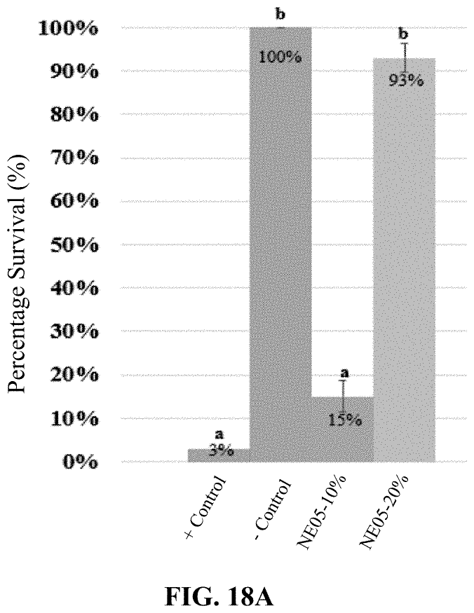

The efficacy of the natural extract NE05 in controlling AHPND was evaluated in vivo by feeding SPF P. vannamei shrimp with diet containing 10% and 20% NE05 followed by an immersion challenge of V. parahaemolyticus causing AHPND. The gross clinical signs of AHPND in bacterial immersion challenged animals maintained on experimental diets are shown in FIGS. 17A-17D. Animals maintained on a commercial diet displayed an empty gastrointestinal tract, whitish or pale appearance of the stomach, and atrophied hepatopancreas. Animals with disease showed lethargy and exoskeleton of the moribund animals were soft. Shrimp fed diet containing NE05 at 10% appeared clinically similar to the animals fed commercial diet (FIG. 17C). In contrast, animals fed diet containing 20% of NE05 did not display any clinical sign of AHPND and appeared clinically similar to unchallenged animals maintained on a commercial diet (FIG. 17D). The results showed that diet containing 20% NE05 were effective in protecting shrimp from AHPND had a 100% survival.

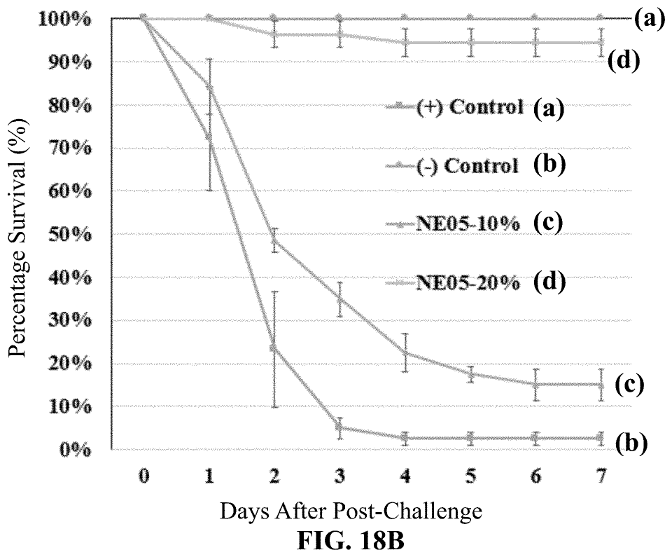

The effect of feeding diet containing the natural extract NE05 to shrimp following 7 days post-AHPND challenge is shown in FIG. 18A. The percent survival of P. vannamei shrimp maintained on a diet containing NE05-20% and challenged with V. parahaemolyticus strain A3 had a significantly higher survival (93%, P<0.05) when compared to animals fed diet containing NE05-10% (15% survival) as well as animals fed commercial diet (3% survival). Shrimp from negative treatment group, i.e. shrimp fed commercial diet and not challenged with AHPND had a 100% survival.

The occurrence of mortality in various treatments following AHPND challenge is shown in FIG. 18B. Mortality in the positive control began at 8 hours post-challenge and within 48 h reached 80%. By day 3 post-challenge mortality reached 97%. In NE05-10% treatment, mortality began at 10 h post-challenge and continued for another 62-h reaching 85% mortality by day 3. No additional mortalities were observed after day 3. Shrimp fed diet containing NE05-20% did not show mortality during the first 24 h post-challenge. By day 2, mortality reached 4%, and thereafter no mortality occurred. No mortality was observed in the negative control treatment.

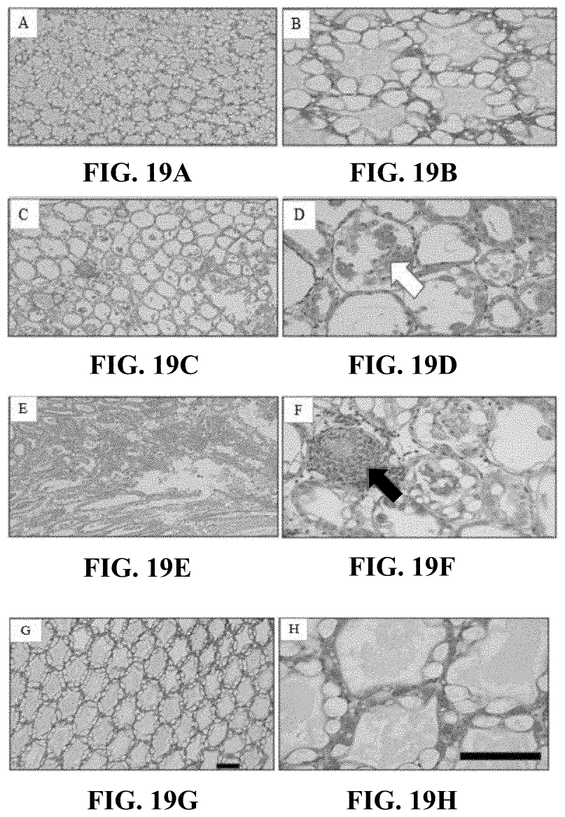

FIGS. 19A-19H shows hematoxylin and eosin (H&E) stained histological sections of hepatopancreatic (HP) tissue of P. vannamei shrimp in different magnification. Histopathology of hepatopancreas tissue derived from positive control treatment, i.e. shrimp fed commercial diet and collected at 24 h. post-challenge with AHPND showed sloughing of epithelial cells of hepatopancreas tubule into the lumen. Mild sloughing of epithelial cells in hepatopancreatic tubule were also observed in animals from NE05-10% treatment. Histopathology of AHPND-challenged shrimp collected at 48 h post-infection from positive control and NE05-10% treatments showed hallmark of AHPND infection which include sloughing of epithelial cells into hepatopancreatic tubule lumen, hemocytic filtration and bacterial lesion (FIGS. 19B-19D and 19F). The severity of infected shrimp collected from these two treatments were G4 (severe damage in HP tissues). In contrast, histopathology of AHPND-challenged shrimp collected at 24 & 48 h post-challenge from NE05-20% and healthy shrimp (negative control) treatments did not show any lesions that are considered pathognomonic of AHPND (FIGS. 19G-H).

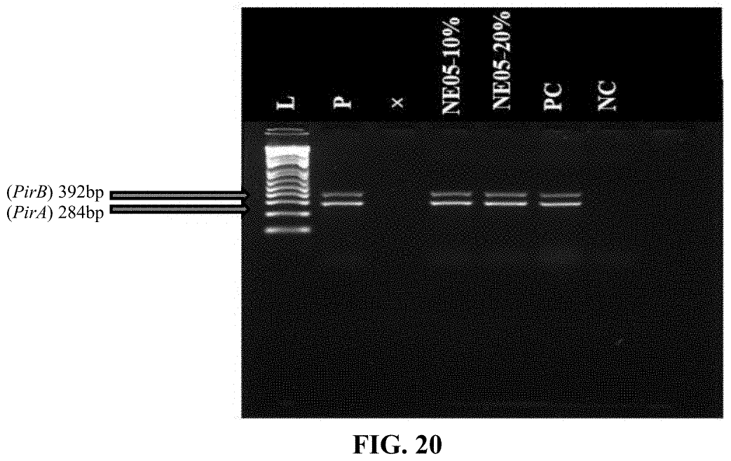

A conventional duplex PCR performed using total genomic DNA isolated from P. vannamei hepatopancreatic tissue from the bioassay successfully detected pirA and pirB genes in samples from the positive control, NE05-10%, and NE05-20% treatments. For NE05-20% group sample were collected from healthy shrimp. This indicates that the animals challenged with V. parahaemolyticus were successfully infected with the pathogenic bacteria. The binary toxin genes were not detected in the animals from the negative control treatment (FIG. 20).

### Discussion

This Example screened 18 NEs and 5 of the NEs showed antimicrobial activities against VPAHPND in a disk diffusion assay with diameters of inhibitory zones ranging from 11.80±0.90 to 26.00±1.80 mm (FIG. 11, Table 2). These results were consistent with published studies in which V. parahaemolyticus (1×10⁶ cfu/ml) growth was shown to be inhibited by plant extracts such as green tea extract that showed diameters of inhibition zones ranging from 14.4-16.4 mm in independent assays (Kongchum et al., 2016). In disk diffusion assay, V. parahaemolyticus growth was shown to be inhibited by natural extracts from plants such as Syzygium cumini, Saraca indica, Terminalia belerica, Datura stramonium, Lawsonia inermis, and Allium sativum with diameters of inhibition zones ranging from 10-19 mm (Sharma et al., 2009).

In a liquid culture assay, the MIC values of NE01, NE02, NE03, NE04 and NE05 were found to be 0.15%, 0.15%, 0.075%, 0.04% and 0.02% (v/v %), respectively. This shows that NE03, NE04 and NE05 have higher efficacy against VPAHPND than NE01 and NE02. In a recent publication, Phung and colleagues determined the MIC values of dried Phyllanthus amarus against VPAHPND as 12.5% which was much higher than MIC values found in this example (Phung et al., 2019). Phyllanthus amarus is a small herb with known medicinal properties against gastrointestinal diseases (Patel et al., 2011). Phung and colleagues used dry powder derived from the whole plant biomass instead of active ingredient(s) isolated from the plant. It is likely this resulted in a high level of incorporation (i.e. 12.5%) of plant biomass rather than incorporating the active ingredients only. Whole plant extract is known to provide nutrients to the microbes which may reduce the effectiveness of natural extracts and induce the growth of pathogen.

There were at least two interesting observations that were made while analyzing the data from the MIC assay. First, there was a declining trend in VPAHPND count with NE05 at 24 and 48 h post-incubation, suggesting that NE05 may have bactericidal effect and is likely to be a promising natural extracted for AHPND treatment. Second, a combination of the three most effective NEs (NE03, NE04 and NE05) had lower MIC values than each of these extracts applied alone, suggesting a combination of these three extracts could be used to control VP_{AHPND}.

Antimicrobial activities of natural extracts could contribute to their bacteriostatic or bactericidal properties that may affect bacterial cell wall and enzymes involved in the metabolism of bacteria (Calvo and Martinez-Martinez, 2009). Scanning electron micrographs showed that NE03, NE04 and NE05 affected bacterial cell wall resulting in its disruption and leaking of intracellular components (FIGS. 16A-16F). It is unknown if the mechanism of action of NE03, NE04 and NE05 is similar to that of the antimicrobial peptides that directly disrupt bacterial cell walls (Correa et al., 2019).

Since NE05 showed the best antimicrobial properties among the five NEs tested, this extract was chosen for assessing the in vivo efficacy against VP_{AHPND} using an experimental AHPND bioassay. In this bioassay, shrimp were fed diets containing two different levels of NE05 (10% and 20%) for 7 days before challenging the animals with VP_{AHPND} using an immersion challenge model. Altogether, three independent VP_{AHPND} challenge experiments were conducted. The average survival rate was significantly higher in shrimp fed the diet containing NE05-20% (93% survival) than shrimp fed a diet containing NE05-10% (15% survival) or a commercial diet (3% survival), suggesting that a 20% incorporation level of NE05 in a commercial diet could be a viable option in developing a diet for controlling AHPND. Animals maintained on a diet containing NE05-20% displayed no clinical signs, and histopathology of hepatopancreas showed no lesions that are pathognomonic of AHPND (FIGS. 17D and 19G-19H). In contrary, animals maintained on a diet containing NE05 (20%) or a commercial diet alone developed clinical signs and lesions in hepatopancreas that are hallmarks of AHPND. Upon the termination of AHPND bioassay, hepatopancreas samples were collected for the detection of pirA and pirB genes by PCR. The results showed that pirA and pirB genes were successfully detected in shrimp fed commercial diet (positive control) as well as in shrimp fed commercial diet containing 10% or 20% NE05. However, pirA and pirB genes were not detected in healthy shrimp that were fed a commercial diet and were not AHPND challenged. The detection of pirA and pirB genes in animals fed a commercial diet or a diet containing NE05-10% was expected since animals in these two groups developed clinical signs and showed high mortality. However, the detection of pirA and pirB genes in animals maintained on a diet containing NE05-20% suggest that the pVA1 plasmids carrying the binary toxin genes was present in hepatopancreas although no histopathology induced by the toxin could be seen. It has been hypothesized that V. parahaemolyticus causing AHPND colonizes the gut and release binary toxin that reaches hepatopancreas through the gastric sieve that connects the gut to hepatopancreas (Prachumwat et al., 2019). Since SEM photograph revealed that NE05 disrupts bacterial cell wall and intracellular contents probably leak out of the cells, it is possible that pVA1 plasmid DNA released in the gut upon disruption of bacterial cell wall reaches the hepatopancreas through gastric sieve. As a result, when genomic DNA is isolated from hepatopancreas tissue, PCR positive result were obtained for the binary toxin genes pirA and pirB. It is possible that the amount of toxins was not enough to cause pathological changes in the hepatopancreas. Irrespective of these findings, it is quite apparent that at least plant derived natural extract NE05 is effective in controlling AHPND.

### REFERENCES CITED IN THIS DISCLOSURE AND EXAMPLES

AftabUddin, S., Siddique, M. A. M., Romkey, S. S., Shelton, W. L., 2017. Antibacterial function of herbal extracts on growth, survival and immunoprotection in the black tiger shrimp Penaeus monodon. Fish Shellfish Immunol. 65, 52-58. https://doi.org/10.1016/j.fsi.2017.03.050
Anderson, B. J. L., Valderrama, D., Jory, D. E., 2018. Global shrimp production review and forecast: Steady growth ahead. Glob. Aquac. Alliance 5-10.
Anderson, J. L., Valderrama, D., Jory, D., 2017. Shrimp Aquaculture Production by World Region: 2000-2017. Glob. Aquac. Alliance 54. https://doi.org/10.1590/S0104-530X2012000200013
Calvo, J., Martinez-Martinez, L., 2009. Mecanismos de acción de los antimicrobianos. Enferm. Infecc. Microbiol. Clin. 27, 44-52. https://doi.org/10.1016/j.eimc.2008.11.001
Campa-Córdova, A. I., León-Gallo, A. F., Romero-Maldonado, A., Ibarra-Serrano, A. C., Rosales-Mendoza, S., Hirono, I., Angulo, C., 2017. Recombinant PirA-like toxin protects shrimp against challenge with Vibrio parahaemolyticus, the aetiological agent of acute hepatopancreatic necrosis disease. J. Fish Dis. 40, 1725-1729. https://doi.org/10.1111/jfd.12625
Chumpol, S., Kantachote, D., Rattanachuay, P., Vuddhakul, V., Nitoda, T., Kanzaki, H., 2017. In vitro and in vivo selection of probiotic purple nonsulphur bacteria with an ability to inhibit shrimp pathogens: acute hepatopancreatic necrosis disease-causing Vibrio parahaemolyticus and other vibrios. Aquac. Res. 48, 3182-3197. https://doi.org/10.1111/are.13149
Corrêa, J. A. F., Evangelista, A. G., Nazareth, T. de M., Luciano, F. B., 2019. Fundamentals on the molecular mechanism of action of antimicrobial peptides. Materialia. https://doi.org/10.1016/j.mtla.2019.100494
Cowan, M. M., 1999. Plant products as antimicrobial agents. Clin. Microbiol. Rev. https://doi.org/10.1128/cmr.12.4.564
Cruz-Flores, R., Mai, H. N., Dhar, A. K., 2019. Multiplex SYBR Green and duplex TaqMan real-time PCR assays for the detection of Photorhabdus Insect-Related (Pir) toxin genes pirA and pirB. Mol. Cell. Probes 43, 20-28. https://doi.org/10.1016/j.mcp.2018.12.004
Dangtip, S., Sirikharin, R., Sanguanrut, P., Thitamadee, S., Sritunyalucksana, K., Taengchaiyaphum, S., Mavichak, R., Proespraiwong, P., Flegel, T. W., 2015. AP4 method for two-tube nested PCR detection of AHPND isolates of Vibrio parahaemolyticus. Aquac. Reports 2, 158-162. https://doi.org/10.1016/j.agrep.2015.10.002
Dhar, Arun K, Luis, R. C., Aranguren, F., Siewiora, H. M., Jory, D., 2019. Diversity of single-stranded DNA containing viruses in shrimp. VirusDisease 30, 43-57. https://doi.org/10.1007/s13337-019-00528-3
Dhar, Arun K., Piamsomboon, P., Caro, L. F. A., Kanrar, S., Adami, R., Juan, Y. S., 2019. First report of acute hepatopancreatic necrosis disease (AHPND) occurring in the USA. Dis. Aquat. Organ. 132, 241-247. https://doi.org/10.3354/dao03330
Dong, X., Bi, D., Wang, H., Zou, P., Xie, G., Wan, X., Yang, Q., Zhu, Y., Chen, M., Guo, C., Liu, Z., Wang, W., Huang, J., 2017. pirAB vp—Bearing Vibrio parahaemolyticus and Vibrio campbellii pathogens isolated from the Same AHPND-affected pond possess highly similar pathogenic plasmids. Front. Microbiol. 8, 1-9. https://doi.org/10.3389/fmicb.2017.01859
Filipović, I., Zdolec, N., Dobranić, V., 2016. Effect of spices on Vibrio parahaemolyticus survival and growth 86, 125-134.
Flegel, T., Lo, C., 2014. Free release of primers for specific detection of bacterial isolates that cause acute hepatopancreatic necrosis disease (AHPND) [WWW Document]. Netw. Aquac. Centres Asia-Pacific, Bangkok, Thailand.
Flegel, T. W., 2019. A future vision for disease control in shrimp aquaculture. J. World Aquac. Soc. 249-266. https://doi.org/10.1111/jwas.12589
Flegel, T. W., 2012. Historic emergence, impact and current status of shrimp pathogens in Asia. J. Invertebr. Pathol. 110, 166-173. https://doi.org/10.1016/j.jip.2012.03.004 Hai, N. V, 2015. The use of probiotics in aquaculture 917-935. https://doi.org/10.1111/jam.12886
Han, J. E., Lee, S. C., Park, S. C., Jeon, H. J., Kim, K. Y., Lee, Y. S., Park, S., Han, S. H., Kim, J. H., Choi, S. K., 2020. Molecular detection of Enterocytozoon hepatopenaei and Vibrio parahaemolyticus-associated acute hepatopancreatic necrosis disease in Southeast Asian Penaeus vannamei shrimp imported into Korea. Aquaculture 517, 734812. https://doi.org/10.1016/j.aquaculture.2019.734812
Han, J. E., Tang, K. F. J., Pantoja, C. R., White, B. L., Lightner, D. V., 2015. QPCR assay for detecting and quantifying a virulence plasmid in acute hepatopancreatic necrosis disease (AHPND) due to pathogenic Vibrio parahaemolyticus. Aquaculture 442, 12-15. https://doi.org/10.1016/j.aquaculture.2015.02.024
Han, Tang, Tran, Lightner, 2015. Photorhabdus insect-related (Pir) toxin-like genes in a plasmid of Vibrio parahaemolyticus, the causative agent of acute hepatopancreatic necrosis disease
(AHPND) of shrimp. Dis. Aquat. Organ. 113, 33-40. https://doi.org/10.3354/dao02830
Hong, X., Lu, L., Xu, D., 2016. Progress in research on acute hepatopancreatic necrosis disease (AHPND). Aquac. Int. 24, 577-593. https://doi.org/10.1007/s10499-015-9948-x Jha, R. K., Babikian, Haig Yousep, Babikian, Haig Yousef, Khoa, L. Van, Wisoyo, D.,
Srisombat, S., Jiaravanon, B., 2016. Efficacy of Natural Herbal Formulation against Acute Hepatopancreatic Necrosis Disease (AHPND) causing Vibrio parahaemolyticus in Penaeus vannamei. Vet. Med.—Open J. 2, 1-6. https://doi.org/10.17140/vmoj-1-109.
Jun, J. W., Han, J. E., Gin, S. S., Tang, K. F. J., Zhou, X., Aranguren, L. F., Kim, H. J., Yun, S., Chi, C., Kim, S. G., Park, S. C., 2018. Phage Application for the Protection from Acute Hepatopancreatic Necrosis Disease (AHPND) in Penaeus vannamei. Indian J. Microbiol. 58, 114-117. https://doi.org/10.1007/s12088-017-0694-9
Karnjana, K., Soowannayan, C., Wongprasert, K., 2019. Ethanolic extract of red seaweed Gracilaria fisheri and furanone eradicate Vibrio harveyi and Vibrio parahaemolyticus biofilms and ameliorate the bacterial infection in shrimp. Fish Shellfish Immunol. 88, 91-101. https://doi.org/10.1016/j.fsi.2019.01.058
Karunasagar, K. V. R. M. M. I., 2012. Monodon Baculovirus of Shrimp 23, 149-160. https://doi.org/10.1007/s13337-012-0086-z
Koiwai, K., Tinwongger, S., Nozaki, R., Kondo, H., Hirono, I., 2016. Detection of acute hepatopancreatic necrosis disease strain of Vibrio parahaemolyticus using loop-mediated isothermal amplification. J. Fish Dis. 39, 603-606. https://doi.org/10.1111/jfd.12387
Kongchum, P., Chimtong, S., Chareansak, N., Subprasert, P., 2016. Effect of Green Tea Extract on Vibrio Parahaemolyticus Inhibition in Pacific White Shrimp (Litopenaeus Vannamei) Postlarvae. Agric. Agric. Sci. Procedia 11, 117-124. https://doi.org/10.1016/j.aaspro.2016.12.020
Kumar, V., Baruah, K., Nguyen, D. V., Smagghe, G., Vossen, E., Bossier, P., 2018.
Phloroglucinol-mediated Hsp70 production in crustaceans: Protection against Vibrio parahaemolyticus in Artemia franciscana and Macrobrachium rosenbergii. Front. Immunol. 9. https://doi.org/10.3389/fimmu.2018.01091
Kv, R., Shivam, S., Praveena, E., 2016. Emergence of Enterocytozoon hepatopenaei (EHP) in farmed Penaeus (Litopenaeus) vannamei in India. https://doi.org/10.1016/j.aquaculture.2015.12.034
Lakshmi, B., Viswanath, B., Gopal, D. V. R. S., 2013. Probiotics as Antiviral Agents in Shrimp Aquaculture 2013.
Lee, C.-T., Chen, I.-T., Yang, Y.-T., Ko, T.-P., Huang, Y.-T., Huang, J.-Y., Huang, M.-F., Lin, S.-J., Chen, C.-Y., Lin, S.-S., Lightner, D. V., Wang, Han-Ching, Wang, A. H.-J., Wang, Hao-Ching, Hor, L.-I., Lo, C.-F., 2015. The opportunistic marine pathogen Vibrio parahaemolyticus becomes virulent by acquiring a plasmid that expresses a deadly toxin. Proc. Natl. Acad. Sci. 112, 10798-10803. https://doi.org/10.1073/pnas.1503129112
Lightner, D. D. V., 1996. A handbook of shrimp pathology and diagnostic procedures for diseases of cultured penaeid shrimp. Louisiana.
Lightner, D. V, Redman, R. M., Pantoja, C. R., Noble, B. L., Nunan, L. M., Tran, L., Sciences, C. B., n.d. Documentation of an Emerging Disease (Early Mortality Syndrome) in SE Asia & Mexico Spread of EMS/AHPNS in East and SE Asia.
Lightner, D. V, Redman, R. M., Pantoja, C. R., Tang, K. F. J., Noble, B. L., Schofield, P., Mohney, L. L., Nunan, L. M., Navarro, S. A., 2012. Historic emergence, impact and current status of shrimp pathogens in the Americas. J. Invertebr. Pathol. 110, 174-183. https://doi.org/10.1016/j.jip.2012.03.006
Liu, L., Jiang, L., Yu, Y., Xia, X., Pan, Y., Yan, S., Wang, Y., 2017. Rapid diagnosis of Vibrio owensii responsible for shrimp acute hepatopancreatic necrosis disease with isothermal recombinase polymerase amplification assay. Mol. Cell. Probes 33, 4-7. https://doi.org/10.1016/j.mcp.2017.02.001
Liu, Q., Meng, X., Li, Y., Zhao, C. N., Tang, G. Y., Li, H. Bin, 2017. Antibacterial and antifungal activities of spices. Int. J. Mol. Sci. https://doi.org/10.3390/ijms18061283
Marc Antonyak, B. A., Lukey, M. J., Cerione, R. A., 2018. The State of World Fisheries and Aquaculture 2018-Meeting the sustainable development goals, Proc. Natl. Acad. Sci. U.S.A. https://doi.org/10.1126/science.aaw5824
Mith, H., Duré, R., Delcenserie, V., Zhiri, A., Daube, G., Clinquart, A., 2014. Antimicrobial activities of commercial essential oils and their components against food-borne pathogens and food spoilage bacteria. Food Sci. Nutr. 2, 403-416. https://doi.org/10.1002/fsn3.116
Mohammed, A., Asely, E., et al. 2011. Changes in the immune-related gene expression of kuruma shrimp Marsupenaeus japonicus in response to dietary inclusion of Macrophage Activating Chinese Herbs (MACH). Egypt. J. Aquat. Biol. & Fish., Vol. 15, No. 3:295-303 (2011) ISSN 1110-6131.
Morales-Covarrubias, 2016. Evaluation of medicinal plants and colloidal silver efficiency against Vibrio parahaemolyticus infection in Litopenaeus vannamei cultured at low salinity. Dis. Aquat. Organ. 122, 57-65. https://doi.org/10.3354/dao03060
Morales-Covarrubias, M. S., Garcia-Aguilar, N., Bolan-Mejia, M. D. C., Puello-Cruz, A. C., 2016a. Evaluation of medicinal plants and colloidal silver efficiency against Vibrio parahaemolyticus infection in Litopenaeus vannamei cultured at low salinity. Dis. Aquat. Organ. 122, 57-65. https://doi.org/10.3354/dao03060
Morales-Covarrubias, M. S., Garcia-Aguilar, N., Bolan-Mejia, M. D. C., Puello-Cruz, A. C., 2016b. Evaluation of medicinal plants and colloidal silver efficiency against Vibrio parahaemolyticus infection in Litopenaeus vannamei cultured at low salinity. Dis. Aquat. Organ. 122, 57-65. https://doi.org/10.3354/dao03060
Netea, M. G., Joosten, L. A. B., Latz, E., Mills, K. H. G., Natoli, G., Stunnenberg, H. G., O'Neill, L. A. J., Xavier, R. J., 2016. Trained immunity: A program of innate immune memory in health and disease. Science (80-.). 352, 427. https://doi.org/10.1126/science.aaf1098 Newman, S., 2019. Why are antibiotic residues in farmed shrimp a big deal? «Global
Pinoargote, G., Flores, G., Cooper, K., Ravishankar, S., 2018. Effects on survival and bacterial community composition of the aquaculture water and gastrointestinal tract of shrimp (Litopenaeus vannamei) exposed to probiotic treatments after an induced infection of acute hepatopancreatic necrosis disease. Aquac. Res. 49, 3270-3288. https://doi.org/10.1111/are.13791
Pope, E. C., Powell, A., Roberts, E. C., Shields, R. J., Wardle, R., Andrew, F., 2011. Enhanced Cellular Immunity in Shrimp (Litopenaeus vannamei) after ‘ Vaccination’ 6, 1-7. https://doi.org/10.1371/journal.pone.0020960
Prachumwat, Taengchaiyaphum, Mungkongwongsiri, A., Flegel, Sritunyalucksana, 2019. Update on early mortality syndrome/acute hepatopancreatic necrosis disease by April 2018 5-17. https://doi.org/10.1111/jwas.12559
Raja Rajeswari, P., Velmurugan, S., Michael Babu, M., Albin Dhas, S., Kesavan, K., Citarasu, T., 2012. A study on the influence of selected Indian herbal active principles on enhancing the immune system in Fenneropenaeus indicus against Vibrio harveyi infection. Aquac. Int. 20, 1009-1020. https://doi.org/10.1007/sI0499-012-9525-5
Ja et al., 2016. Vet. Med. 2(1):1-6. https://doi.org/10.17140NMOJ-1-109
Randrianarivelo, R., Sarter, S., Odoux, E., Brat, P., Lebrun, M., 2009. Composition and antimicrobial activity of essential oils of Cinnamosma fragrans 114, 680-684.
Ravishankar, S., Zhu, L., Reyna-granados, J., Law, B., Joens, L., Friedman, M., 2010. Carvacrol and Cinnamaldehyde Inactivate Antibiotic-Resistant Salmonella enterica in Buffer and on Celery and Oysters 73, 234-240.
Santos, H. M., Tsai, C., Maquiling, K. R. A., Tayo, L. L., Mariatulqabtiah, A. R., Lee, C., Chuang, K. P., 2020. Diagnosis and potential treatments for acute hepatopancreatic necrosis disease (AHPND): a review 169-185.
Santos, H. M., Tsai, C., Maquiling, K. R. A., Tayo, L. L., Mariatulqabtiah, A. R., Lee, C., Chuang, K. P., 2019. Diagnosis and potential treatments for acute hepatopancreatic necrosis disease (AHPND): a review.
Sharma, A., Patel, V. K., Chaturvedi, A. N., 2009. Vibriocidal activity of certain medicinal plants used in Indian folklore medicine by tribals of Mahakoshal region of central India. Indian J. Pharmacol. 41, 129-133. https://doi.org/10.4103/0253-7613.55212
Sivasankar, P., Anix Vivek Santhiya, A., Kanaga, V., 2015. A review on plants and herbal extracts against viral diseases in aquaculture. J. Med. Plants Stud. 3, 75-79.
Thornber, K., Verner-Jeffreys, D., Hinchliffe, S., Rahman, M. M., Bass, D., Tyler, C. R., 2019. Evaluating antimicrobial resistance in the global shrimp industry. Rev. Aquac. 1-21. https://doi.org/10.1111/raq.12367
Tinwongger, S., Proespraiwong, P., Thawonsuwan, J., Sriwanayos, P., Kongkumnerd, J., Chaweepack, T., Mavichak, R., Unajak, S., Nozaki, R., Kondo, H., Hirono, I., 2014. Development of PCR diagnosis for shrimp Acute Hepatopancreatic Necrosis Disease (AHPND) strain of Vibrio parahaemolyticus. Fish Pathol. 49, 159-164. https://doi.org/10.3147/jsfp.49.159
Tran, L, Nunan, L., Redman, R., Mohney, L., Pantoja, C., Fitzsimmons, K., Lightner, D., 2013. Determination of the infectious nature of the agent of acute hepatopancreatic necrosis syndrome affecting penaeid shrimp. Dis. Aquat. Organ. 105, 45-55. https://doi.org/10.3354/dao02621
Tran, Loc, Nunan, L., Redman, R. M., Mohney, L. L., Pantoja, C. R., Fitzsimmons, K., Lightner, D. V., 2013. Determination of the infectious nature of the agent of acute hepatopancreatic necrosis syndrome affecting penaeid shrimp. Dis. Aquat. Organ. 105, 45-55. https://doi.org/10.3354/dao02621
Trejo-Flores, J. V., Luna-González, A., Álvarez-Ruíz, P., Escamilla-Montes, R., Peraza-Gómez, V., Diarte-Plata, G., Esparza-Leal, H. M., Campa-Córdova, Á. I., Gámez-Jiménez, C., Rubio-Castro, A., 2016. Protective effect of Aloe vera in Litopenaeus vannamei challenged with Vibrio parahaemolyticus and white spot syndrome virus. Aquaculture 465, 60-64. https://doi.org/10.1016/j.aquaculture.2016.08.033
Tsai, C., Santos, H. M., Hu, S., Sang, C. Y., Nitura, K. M. A., Liu, C. H., Chuang, K. P., 2019. LpxD gene knockout elicits protection to Litopenaeus vannamei, white shrimp, against Vibrio parahaemolyticus infection 1383-1393.
Tv, P., Pt, H. Y., Nq, L., 2019. Asploro Journal of Biomedical and Clinical Case Reports Antibacterial Activity of Extracts from Dried and Fresh Herbal Plant (Phyllanthus amarus) Against Pathogens Causing Acute Hepatopancreatic Necrosis Disease (Ahpnd) in White Leg Shrimp (Litopenaeus vannamei) at Thua Thien Hue Province, Vietnam 2019, 120-128.
Wang, H., Wang, C., Tang, Y., Sun, B., Huang, J., Song, X., 2018. Pseudoalteromonas probiotics as potential biocontrol agents improve the survival of Penaeus vannamei challenged with acute hepatopancreatic necrosis disease (AHPND)-causing Vibrio parahaemolyticus. Aquaculture 494, 30-36. https://doi.org/10.1016/j.aquaculture.2018.05.020
Wangman, P., Chaivisuthangkura, P., Sritunyalucksana, K., Taengchaiyaphum, S., Senapin, S., Pengsuk, C., Sithigorngul, P., Longyant, S., 2017. Development of monoclonal antibodies specific to ToxA and ToxB of Vibrio parahaemolyticus that cause acute hepatopancreatic necrosis disease (AHPND). Aquaculture 474, 75-81. https://doi.org/10.1016/j.aquaculture.2017.03.039
Yang, Q., Dong, X., Xie, G., Fu, S., Zou, P., Sun, J., Wang, Y., Huang, J., 2019. Comparative genomic analysis unravels the transmission pattern and intra-species divergence of acute hepatopancreatic necrosis disease (AHPND)-causing Vibrio parahaemolyticus strains. Mol. Genet. Genomics 294, 1007-1022. https://doi.org/10.1007/s00438-019-01559-7

Various modifications and variations of the described methods, pharmaceutical compositions, and kits of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

Further attributes, features, and aspects of the present invention can be understood by reference to the following numbered aspects of the disclosed invention. Reference to disclosure in any of the preceding embodiments is applicable to any preceding numbered embodiment and to any combination of any number of preceding aspects, as recognized by appropriate antecedent disclosure in any combination of preceding embodiments that can be made. The following numbered aspects are provided:
1. A formulation comprising:
an amount of each of one or more plant extracts selected from the group consisting of: cinnamon oil (CO), citral, cavacrol, oregano oil (OO), trans cinnamaldehyde (TC), and combinations thereof.
2. The formulation of aspect 1, wherein the formulation comprises a plant extract component consisting of: an amount of each of TC, OO, and cavacrol.
3. The formulation of aspect 1, wherein the amount of CO ranges from about 10-60% v/v.
4. The formulation of any one of aspects 1 or 3, wherein the amount of CO is about 20% v/v.
5. The formulation of aspect 1, wherein the amount of citral ranges from about 10-60% v/v.
6. The formulation of any one of aspects 1 or 3-5, wherein the amount of citral is about is about 20% v/v.
7. The formulation of any one of aspects 1-6, wherein the amount of cavacrol ranges from about 10-60% v/v.
8. The formulation of any one of aspects 1-7, wherein the amount of cavacrol is about 20% v/v.
9. The formulation of any one of aspects 1-8, wherein the amount of OO ranges from about 10-60% v/v.
10. The formulation of any one of aspects 1-9, wherein the amount of OO is about 20% v/v.
11. The formulation of any one of aspects 1-10, wherein the amount of TC ranges from about 10-60% v/v.
12. The formulation of any one of aspects 1-11, wherein the amount of TC is about 20% v/v.
13. The formulation of any one of aspects 1-12, wherein the formulation comprises an amount of TC and an amount of cavacrol.
14. The formulation of claim 13, wherein the ratio of TC: cavacrol is 1:1.
15. The formulation of any one of aspects 1-14, wherein the formulation comprises an amount of TC and an amount of 00.
16. The formulation of any one of aspects 1-15, wherein the ratio of TC:OO is 1:1.
17. The formulation of any one of aspects 1-16, wherein the formulation comprises OO and cavacrol.
18. The formulation of any one of aspects 1-17, wherein the ratio of OO:cavacrol is 1:1.
19. The formulation of any one of aspects 1-18, wherein the formulation comprises an amount of TC, and amount of OO, and an amount of cavacrol.
20. The formulation of any one of aspects 1-19, wherein the ratio of TC:OO:cavacrol is 1:1:1.
21. The formulation of any one of aspects 1-20, wherein the formulation is effective to treat or prevent an infection caused by a Vibrio spp. organism.
22. The formulation of any one of aspects 1-21, wherein the formulation is effective to treat or prevent an infection caused by a Vibrio spp. organism in a shrimp.
23. The formulation of any one of aspects 1-22, wherein the formulation is adapted for delivery in a water source.
24. The formulation of any one of aspects 1-23, wherein the formulation is adapted for delivery via an animal feed.
25. A method comprising:
administering an amount of a formulation as in any one of aspects 1-24 to a subject.
26. The method of aspect 25, wherein the subject is a non-human animal.
27. The method of any one of aspects 25-26, wherein the subject is a crustacean.
28. The method of any one of aspects 25-27, wherein the subject is a shrimp.
29. The method of any one of aspects 25-28, wherein administration is via a feed source.
30. The method of any one of aspects 25-29, wherein administration is via a water source.
31. The method of any one of aspects 25-30, wherein the subject is infected with, is suspected of being infected with an organism of a Vibrio spp., or will be exposed to an organism of a Vibrio spp.
32. The method of any one of aspects 25-31, wherein the subject is currently exposed to or was exposed to an organism of a Vibrio spp.
33. A method of treating or preventing a Vibrio spp. infection in a subject comprising:
administering amount of a formulation as in any one of aspects 1-24 to a subject.
34. The method of aspect 33, wherein the subject is a non-human animal.
35. The method of any one of aspects 33-34, wherein the subject is a crustacean.
36. The method of any one of aspects 33-35, wherein the crustacean is a shrimp.
37. The method of any one of aspects 33-36, wherein administration is via a feed source.
38. The method of any one of aspects 33-37, wherein administration is via a water source.
39. The method of any one of aspects 33-38, wherein the subject is infected with, is suspected of being infected with an organism of a Vibrio spp., or will be exposed to an organism of a Vibrio spp.
40. The method of any one of aspects 33-39, wherein the subject is currently exposed to or was exposed to an organism of a Vibrio spp.

What is claimed is:

1. A formulation comprising:
an amount of each of one or more plant extracts selected from the group consisting of: cinnamon oil (CO), citral, cavacrol, oregano oil (OO), trans cinnamaldehyde (TC), and combinations thereof.

2. The formulation of claim 1, wherein the formulation comprises:
a plant extract component consisting of an amount of each of TC, OO, and cavacrol.

3. The formulation of claim 1, wherein the amount of CO ranges from about 10% to about 60% v/v.

4. The formulation of claim 1, wherein the amount of CO is about 20% v/v.

5. The formulation of claim 1, wherein the amount of citral ranges from about 10% to about 60% v/v.

6. The formulation of claim 5, wherein the amount of citral is about 20% v/v.

7. The formulation of claim 1, wherein the amount of cavacrol ranges from about 10% to about 60% v/v.

8. The formulation of claim 7, wherein the amount of cavacrol is about 20% v/v.

9. The formulation of claim 1, wherein the amount of OO ranges from about 10% to about 60% v/v.

10. The formulation of claim 9, wherein the amount of OO is about 20% v/v.

11. The formulation of claim 1, wherein the amount of TC ranges from about 10% to about 60% v/v.

12. The formulation of claim 11, wherein the amount of TC is about 20% v/v.

13. The formulation of claim 1, wherein the formulation comprises an amount of TC and an amount of cavacrol.

14. The formulation of claim 13, wherein the ratio of TC: cavacrol is 1:1.

15. The formulation of claim 1, wherein the formulation comprises an amount of TC and an amount of 00.

16. The formulation of claim 15, wherein the ratio of TC:OO is 1:1.

17. The formulation of claim 1, wherein the formulation comprises OO and cavacrol.

18. The formulation of claim 17, wherein the ratio of OO:cavacrol is 1:1.

19. The formulation of claim 1, wherein the formulation comprises an amount of TC, and amount of OO, and an amount of cavacrol.

20. The formulation of claim 19, wherein the ratio of TC:OO:cavacrol is 1:1:1.

21. The formulation of claim 1, wherein the formulation is effective to treat or prevent an infection caused by a Vibrio spp. organism.

22. The formulation of claim 1, wherein the formulation is effective to treat or prevent an infection caused by a Vibrio spp. organism in a shrimp.

23. The formulation of claim 1, wherein the formulation is adapted for delivery in a water source.

24. The formulation of claim 1, wherein the formulation is adapted for delivery via an animal feed.

25. A method comprising:
administering an amount of a formulation as in any one of claims 1-24 to a subject.

26. The method of claim 25, wherein the subject is a non-human animal.

27. The method of claim 25, wherein the subject is a crustacean.

28. The method of claim 25, wherein the subject is a shrimp.

29. The method of claim 25, wherein administration is via a feed source.

30. The method of claim 25, wherein administration is via a water source.

31. The method of claim 25, wherein the subject is infected with, is suspected of being infected with an organism of a Vibrio spp., or will be exposed to an organism of a Vibrio spp.

32. The method of claim 25, wherein the subject is currently exposed to or was exposed to an organism of a Vibrio spp.

33. A method of treating or preventing a Vibrio spp. infection in a subject comprising:
administering amount of a formulation as in any one of claims 1-24 to a subject.

34. The method of claim 33, wherein the subject is a non-human animal.

35. The method of claim 33, wherein the subject is a crustacean.

36. The method of claim 35, wherein the crustacean is a shrimp.

37. The method of claim 33, wherein administration is via a feed source.

38. The method of claim 33, wherein administration is via a water source.

39. The method of claim 33, wherein the subject is infected with, is suspected of being infected with an organism of a Vibrio spp., or will be exposed to an organism of a Vibrio spp.

40. The method of claim 33, wherein the subject is currently exposed to or was exposed to an organism of a Vibrio spp.


SEQUENCE LISTING (4 sequences)

SEQ ID NO: 1 - DNA, 23 bp, Artificial Sequence
  Forward primer for amplicon of pirA gene (VpPirA-284F)
tgactattctcacgattggactg

SEQ ID NO: 2 - DNA, 22 bp, Artificial Sequence
  Reverse primer for amplicon of pirA gene (VpPirA-284R)
tgactatttcacgattggactg

SEQ ID NO: 3 - DNA, 17 bp, Artificial Sequence
  Forward primer for amplicon of pirB gene (VpPirB-392F)
tgaagtgatgggtgctc

SEQ ID NO: 4 - DNA, 17 bp, Artificial Sequence
  Reverse primer for amplicon of pirB gene (VpPirB-392R)
aagcgccgtttaactca